(19) United States
(12) Patent Application Publication
(10) Pub. No.: US 2025/0092896 A1
(43) Pub. Date: Mar. 20, 2025

(54) CONNECTING ARRANGEMENT COMPRISING A PROTECTIVE ELEMENT AND VEHICLE APPARATUS

(71) Applicant: WITTE Automotive GmbH, Velbert (DE)

(72) Inventors: Zafer GÜL, Wuppertal (DE); Jan Christian BENTE, Sprockhövel (DE); Thomas GLAS, Farmington Hills, MI (US); Harry PURWIN, Ratingen (DE); Klaus SPICKENHEIER, Iserlohn (DE)

(21) Appl. No.: 18/884,217

(22) Filed: Sep. 13, 2024

(30) Foreign Application Priority Data
Sep. 15, 2023 (DE) 10 2023 124 976.2

(51) Int. Cl. F16B 5/02; B60Q 1/00

(52) U.S. Cl. CPC F16B 5/0233; B60Q 1/0005

(57) ABSTRACT

A connecting arrangement for connecting two components may have at least one connecting unit and additionally a protective element. The protective element may have at least one first connection point for connection to the connecting unit and at least one second connection point for connection to at least one of the components. The at least one of the connection points and/or the protective element is or are designed to be flexible at least in regions and/or at points when a force is applied.

### FIELD

The invention relates to a connecting arrangement comprising a protective element, to a protective system for a vehicle apparatus and to a vehicle apparatus comprising such a connecting arrangement.

### BACKGROUND

More and more vehicles are being designed such that the risk of injury to a pedestrian in the event of a collision with a vehicle is as low as possible. For example, if a possible collision between a pedestrian and a vehicle is identified, the hood is automatically raised.

The object of the present invention is to provide a connecting arrangement (also referred to as a connecting device) for connecting two components and a protective system as well as a vehicle apparatus comprising such a connecting arrangement, which reduces or damps mechanical stress in the region of the connecting arrangement, in particular reduces impact energy from a pedestrian or an animal or the like.

The first object is achieved according to the invention by a connecting arrangement having the features of claim 1. The second object is achieved according to the invention by a protective system having the features of claim and the third object is achieved according to the invention by a vehicle apparatus having the features of claim 16.

The connecting arrangement for connecting two components, in particular while compensating for tolerances, comprises at least one connecting unit for connecting the two components and additionally a protective element which is designed to be flexible at least in some regions and/or at some points. The additional protective element has at least one first connection point for connection to the connecting unit and at least one second connection point for connection to at least one of the components, wherein at least one of the connection points and/or the protective element is designed to be flexible at least in regions and/or at points when a force, in particular a minimum force, acts in particular on the component in question and/or on the tolerance compensation device.

In particular, at least one of the connection points and/or the protective element is/are designed to be flexible in some regions and/or at some points such that a connection at this at least one connection point is or can be released automatically. As a result, a connection release means is formed in a simple manner by means of such flexibility in regions and/or at points of the at least one connection point and/or the protective element.

Preferably, the connecting unit can be designed, for example, as a tolerance compensation device having a tolerance compensation element. For example, the tolerance compensation device can have at least one base element and a compensation element that is in threaded engagement with the base element and can move relative to the base element by being rotated in order to compensate for tolerances.

The first connection point and/or the second connection point can, for example, be designed to be flexible such that, when a force, in particular a minimum force, is applied to the component and/or to the connecting unit, in particular to the tolerance compensation device, they can be reversibly separated, in particular reversibly released at predetermined separation points, or irreversibly separated, in particular separated at predetermined breaking points. Alternatively or additionally, the first connection point and/or the second connection point can be designed to be flexible such that at least regions of the component in question move to a limited extent in the application direction relative to the connecting unit, in particular to the tolerance compensation device, and/or to the other component. For example, the connecting unit is or can be connected to the protective element in the region of the first connection point, for example reversibly releasably, for example releasably clamped, releasably snapped in or releasably screwed thereto.

### SUMMARY

In other words, the object is achieved according to the invention by a device for connecting two components by means of a connecting element which is or can be coupled to a protective element through the connecting unit. The protective element comprises the at least one first connection point for connection to the connecting element and the at least one second connection point for connection to at least one of the components, wherein at least one of the connection points and/or the protective element is or are designed to be flexible at least in regions and/or at points when a force is applied.

The second object is achieved according to the invention by a protective system for a vehicle apparatus, in particular a headlight, comprising the above-described connecting arrangement, in particular a tolerance compensation device, or the above-described device for connecting two components.

The third object is achieved according to the invention by a vehicle apparatus, in particular a headlight, comprising the protective system described above.

The exemplary embodiments and developments of the invention described below relate not only to the connecting arrangement, in particular designed as a tolerance compensation device, but also to the device described above and to the protective system and the vehicle apparatus.

The connecting unit, in particular the tolerance compensation device, has, in addition to the first connection point between the tolerance compensation element and the protective element, a second connection point between the protective element and one of the components. The protective element can, on the one hand, be connected to the tolerance compensation element via the at least one first connection point and, on the other hand, be connected to one of the components via the at least one second connection point.

In addition to the first connection point between the one component and the protective element, the device has a second connection point between the protective element and the other component. The protective element can, on the one hand, be connected to the tolerance compensation element or to the one component via the at least one first connection point and, on the other hand, be connected to one of the components or to the other component via the at least one second connection point. For example, a component in the region of the second connection point can be reversibly releasably connectable or connected to the protective element, for example releasably clamped, releasably snapped-in or releasably screwed thereto.

The advantages achieved by the invention in particular consist in that by designing the at least one connection point as a flexible connection, in particular to be flexibly separable and/or flexibly movable, and/or the protective element to be reversibly movable and/or flexibly and irreversibly separable, impact energy from a pedestrian or any other mechanical stress can be reduced, in particular damped. At the same time, such a flexible connection reduces major damage to the components, for example to a main headlight, or even prevents damage to the components, since these components move out of the way in the event of a collision, including with a solid obstacle, and in particular are moved away from this collision region. This in turn can reduce or even obviate repair costs. In addition, vehicles with such a connecting arrangement comprising such a flexible, in particular reversibly releasable, connection can be classified in a more favorable vehicle insurance class.

Preferably, the connecting unit, in particular the tolerance compensation element, and the protective element are designed to be reversibly connected to one another, in particular by clamping and/or snapping-in, in the region of the first connection point.

Alternatively or additionally, the at least one component and the protective element can be designed to be reversibly connected to one another, in particular by clamping and/or snapping-in, in the region of the second connection point.

For example, the protective element can be designed as a spring plate. Alternatively, the protective element may comprise a resilient portion. The one component or the connecting unit, in particular the tolerance compensation element, can have a ramp. Conversely, the protective element can have a ramp and the one component or the connecting unit, in particular the tolerance compensation element, can be designed in portions as a spring plate or comprise a resilient portion.

In particular, the protective element can, on the one hand, be fixedly or releasably arranged on the connecting unit, in particular on the tolerance compensation element, and, on the other hand, be releasably connectable to the one component.

A further exemplary embodiment provides that the protective element be designed as a spring element. In addition, the protective element and/or at least one of the components can be provided with an integrated nut element.

Furthermore, the protective element can have, for example, a snap-in-in element or a clamping element at a free end. The ramp can in particular be designed to correspond to the free end. For example, the ramp may have a flatter rise in the connecting direction than in the opposite opening direction.

This allows the protective element to be reversibly latched onto the ramp in the connecting direction by means of its snap-in-in element or its clamping element. To release or unlatch the connection, an opening force is required that overcomes the steep rise of the ramp and releases the snap-in element or the clamping element from engagement with the ramp.

In addition, at least one compression rib (reversible) can be provided to ensure clearance-free connection between the two components. For example, a first compression rib, in particular an arcuate compression bridge, can extend in the vertical direction in order to compensate for tolerances in the vertical direction. A second compression rib, in particular an arcuate compression bridge, may extend in the transverse direction to compensate for tolerances in the transverse direction. This means that the protective element is mounted clearance-free in at least two directions and is therefore quiet.

In addition, a connecting element, in particular a connecting screw or a connecting bolt, such as a threaded bolt, can be provided, which is or can be coupled to the protective element through the connecting unit, in particular the tolerance compensation device.

### DESCRIPTION OF THE FIGURES

Exemplary embodiments of the invention are explained in greater detail with reference to the drawings. In the figures:

FIG. 1 is a schematic exploded view and a side view of a connecting arrangement designed, for example, as a tolerance compensation device, comprising a protective element having an irreversible predetermined breaking point,

FIG. 2 is a schematic exploded view and a perspective view of the tolerance compensation device comprising the protective element,

FIG. 3 is a schematic side view of the tolerance compensation device in the assembled state,

FIG. 4 is a schematic sectional exploded view of the tolerance compensation device before being mounted on a component,

FIG. 5 is a schematic sectional exploded view of the tolerance compensation device mounted on a component and before the mounting of another component on the tolerance compensation device,

FIG. 6 is a schematic sectional view of the tolerance compensation device when connected to the two components, thereby compensating for axial tolerances between these two components,

FIG. 7 is a schematic sectional view of the tolerance compensation device according to FIG. 6 comprising a flexible connection point that is formed between one of the components and a protective element of the tolerance compensation device,

FIG. 8 is a schematic plan view of the tolerance compensation device according to FIG. 6 with lateral constrictions in one of the components,

FIG. 9 is a schematic sectional view through the component and a base plate of the protective element in the region of the lateral constrictions,

FIG. 10 is a schematic exploded view of another embodiment of a tolerance compensation device

FIG. 11 is a schematic exploded perspective view of the tolerance compensation device according to FIG. 10,

FIG. 12 is a schematic side view of the tolerance compensation device according to FIG. 10 in the assembled state,

FIG. 13 is a schematic sectional view of the tolerance compensation device according to FIG. 12 pre-installed on one component,

FIG. 14 is a schematic sectional exploded view of the tolerance compensation device according to FIG. 12 pre-assembled on a component and before the mounting of another component on the tolerance compensation device,

FIG. 15 is a schematic sectional view of the tolerance compensation device when connected to the two components, thereby compensating for axial tolerances between these two components,

FIG. 16 is a schematic sectional view of the tolerance compensation device according to FIG. 15, comprising a flexible connection point that is formed between one of the components and a protective element of the tolerance compensation device,

FIG. 17 is a schematic plan view of the tolerance compensation device according to FIG. 16 with constrictions as predetermined breaking points in a base plate of the protective element,

FIG. 18 is a schematic plan view of the tolerance compensation device according to FIG. 17 with lateral constrictions in one of the components, FIG. 19 is a schematic sectional view through the component and the base plate of the protective element in the region of the lateral constrictions of the component,

FIGS. 20 to 28 are different schematic representations of an embodiment of a tolerance compensation device comprising a protective element with a reversibly releasable separation point,

FIGS. 29 to 32 are different schematic representations of alternative separation points of the tolerance compensation device,

FIGS. 33 to 36 are different schematic representations of another embodiment of a tolerance compensation device comprising a protective element with a reversibly releasable separation point,

FIGS. 37 to 38 are different schematic representations of another embodiment of a tolerance compensation device having a protective element with a reversibly releasable separation point,

FIGS. 39 to 43 are different schematic representations of an embodiment of a device for connecting at least two components, having a protective element with a reversibly releasable separation point,

FIGS. 44 to 56 are different schematic representations of another embodiment of a device for connecting at least two components, having a protective element with a reversibly releasable separation point,

FIGS. 57 to 58 are a schematic sectional view and a schematic perspective view of a further device for connecting at least two components, comprising a protective element with a reversibly releasable separation point and a connecting unit that comprises a compensation element designed as a compression limiter and a base element with an integrated internal thread,

FIGS. 59 to 60 schematically show a sectional view and a perspective view of a further device for connecting at least two components, having a protective element with a reversibly releasable separation point and a connecting unit that comprises a compensation element with an integrated nut element and a base element comprising an internal thread,

FIGS. 61 to 62 schematically show a sectional view and a perspective view of a further device for connecting at least two components, having a protective element with a reversibly releasable separation point and a connecting unit that comprises a compensation element with integrated internal thread and external thread and a base element comprising an internal thread, and

FIG. 63 is a schematic sectional view of a further device for connecting at least two components, having a protective element with a reversibly releasable separation point and a connecting unit, comprising a connecting element, designed as a hollow bolt, and a base element comprising an internal thread.

### DETAILED DESCRIPTION

Parts corresponding to one another are provided with the same reference signs in all the drawings.

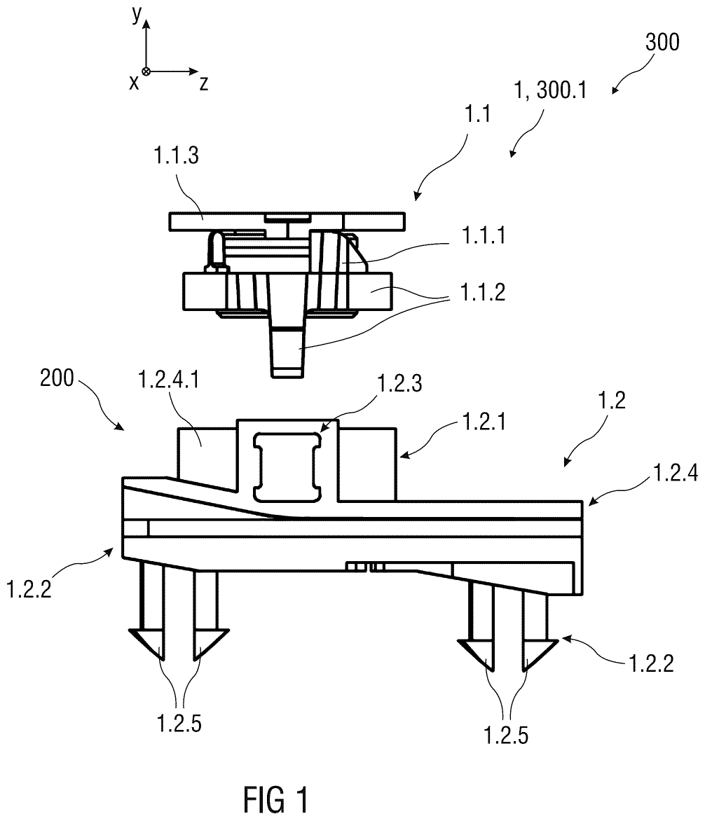

FIG. 1 schematically shows an exploded view and side view of a first embodiment of a connecting arrangement 300 having a connecting unit 300.1 designed as a tolerance compensation device 1 with a tolerance compensation element 1.1 and a protective element 1.2 (also called a pedestrian protection unit or pedestrian protection adapter).

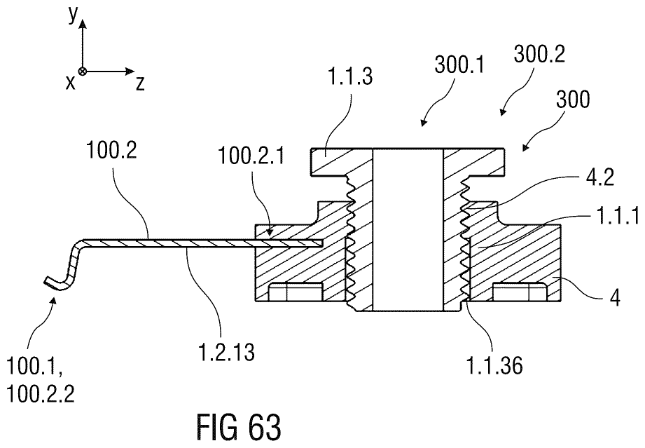

The connecting unit 300.1 can be designed as a tolerance compensation device 1. Alternatively, the connecting unit 300.1 can also be designed as a screw connection 300.2, as shown in FIG. 63, which is additionally provided with the protective element 1.2.

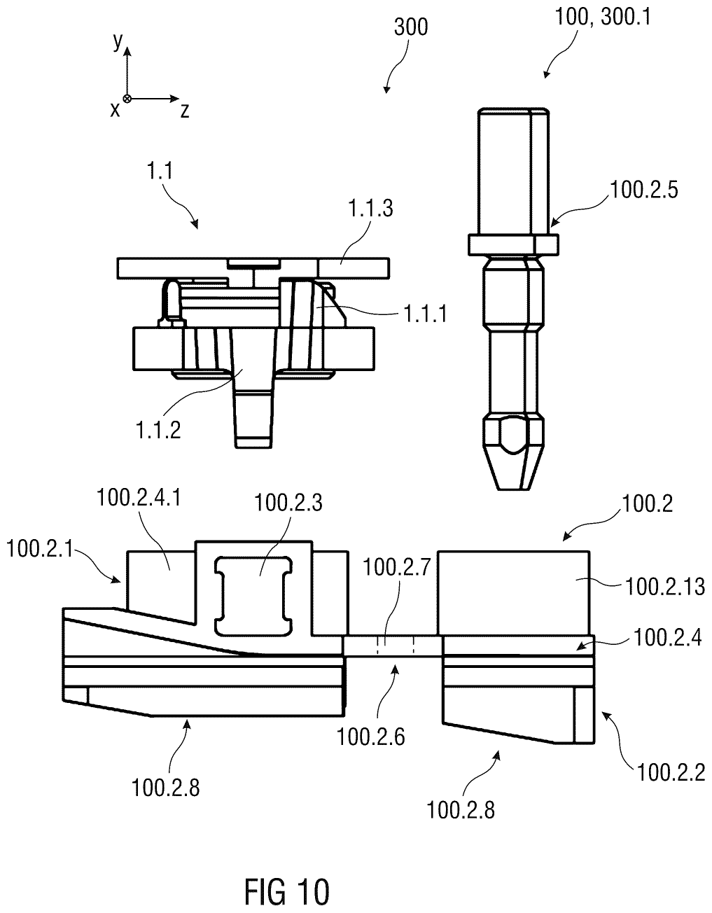

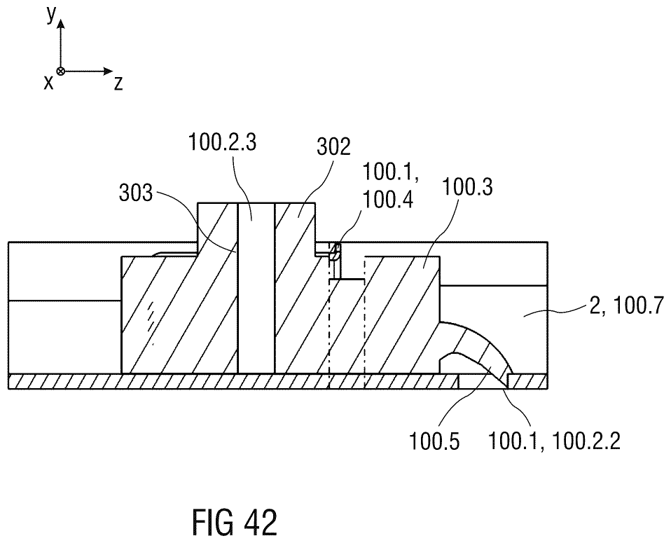

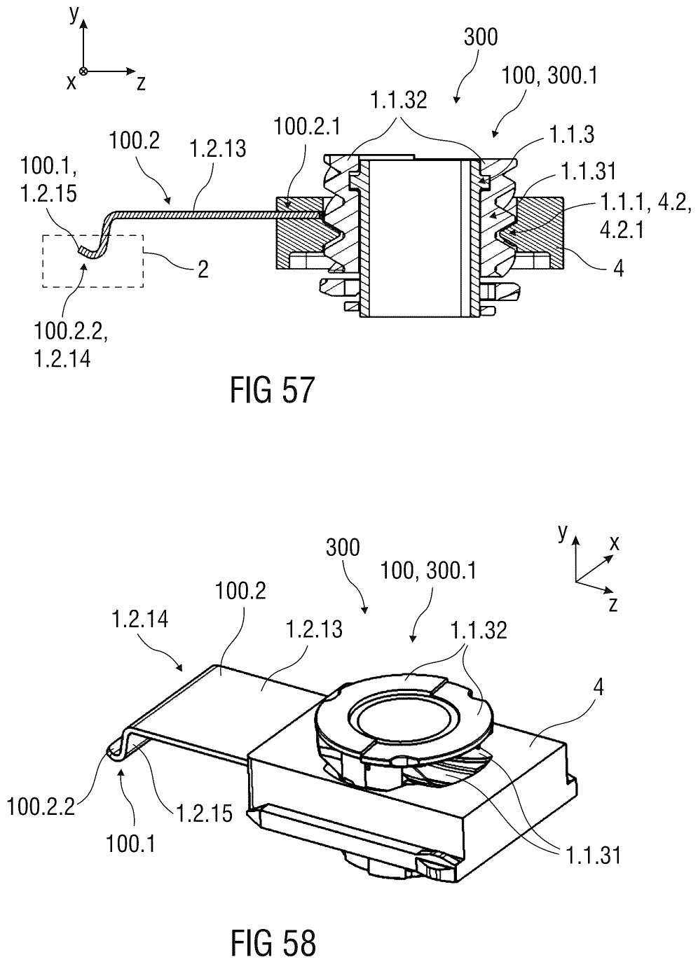

The connecting unit 300.1 will be below using the example of the tolerance compensation device 1 according to FIGS. 1 to 9, the example of the tolerance compensation device 100 according to FIGS. 10 to 56, the example of the tolerance compensation device 100 according to FIGS. 57 to 62 and the example of the screw connection 300.2 according to FIG. 63.

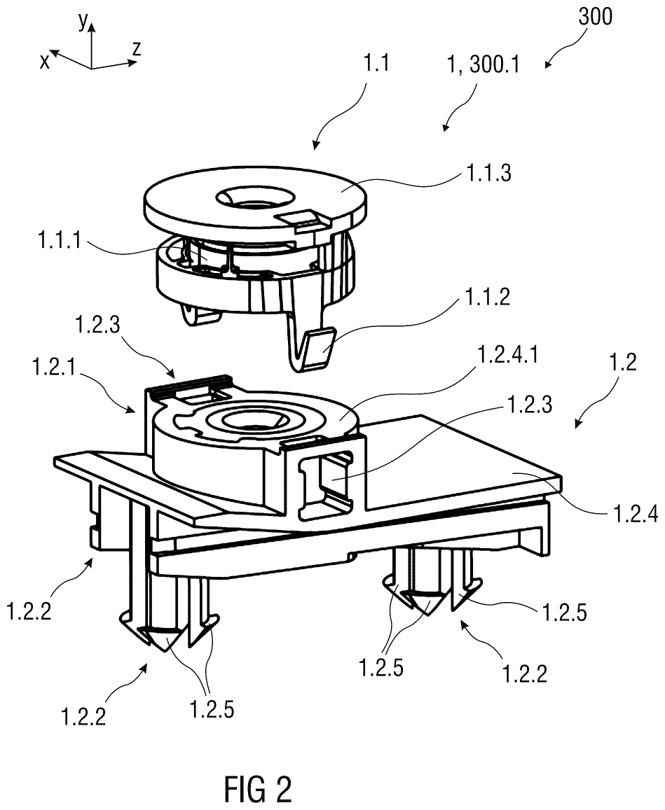

FIG. 2 schematically shows an exploded view and a perspective view of the tolerance compensation device 1 having the protective element 1.2.

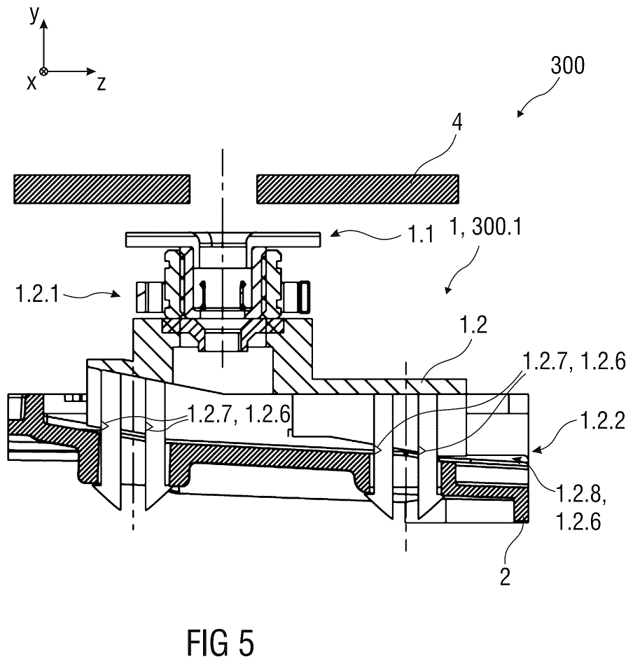

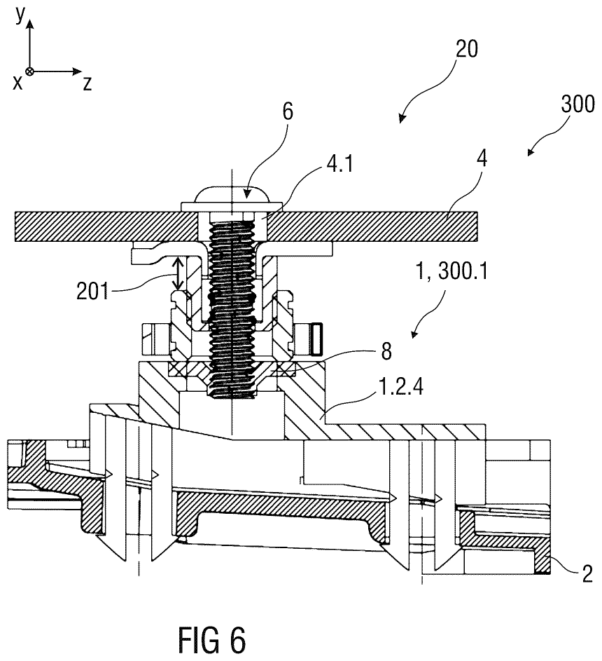

The tolerance compensation device 1 serves to connect two components 2 and 4 (shown in FIG. 5) while compensating for tolerances 201, in particular axial tolerances 201 (shown in FIG. 6).

The tolerance compensation device 1 is used, for example, in a vehicle for connecting two vehicle components, such as a headlight and a vehicle panel, in particular for connecting a headlight to a vehicle panel (also called vehicle skin) while compensating for axial tolerances 201 and/or radial tolerances.

The tolerance compensation device 1 is designed to provide pedestrian protection by means of the protective element 1.2 in addition to the axial tolerance compensation by means of the tolerance compensation element 1.1. The protective element 1.2 and the tolerance compensation element 1.1 are designed to interact with one another in the assembled state in such a way that in the event of a collision with a pedestrian or another object, impact energy acting on at least one of the components 2, 4 is reduced. By reducing the impact energy, pedestrian protection is achieved in a simple way and injuries can be minimized.

The tolerance compensation element 1.1 comprises at least one base element 1.1.1, in particular a hollow-cylindrical sleeve having an internal thread or an external thread, a separate retaining element 1.1.2 or a retaining element integrated into the base element 1.1.1 or a compensation element 1.1.3, for example clip arms or latching arms, and the compensation element 1.1.3 which is in threaded engagement with the base element 1.1.1 and which can move relative to the base element 1.1.1 by being rotated in order to compensate for axial tolerances 201.

The tolerance compensation element 1.1 is a conventional compensation element 1.1.3, as described, for example, in the older document DE 10 2023 205 661.5.

The protective element 1.2 comprises at least a first connection point 1.2.1 for connection to the tolerance compensation element 1.1 and at least a second connection point 1.2.2 for connection to a first component 2 (shown in FIG. 5).

The first connection point 1.2.1 is designed, for example, as a receptacle 1.2.3, in particular a latching receptacle or clamping receptacle, for the retaining element 1.1.2 of the tolerance compensation element 1.1.

The second connection point 1.2.2 where the protective element 1.2 is connected to the first component 2, for example a vehicle skin or a vehicle panel, is designed as a flexible connection. In particular, the second connection point 1.2.2 is designed to be flexible at least in some regions and/or at some points when a force is applied.

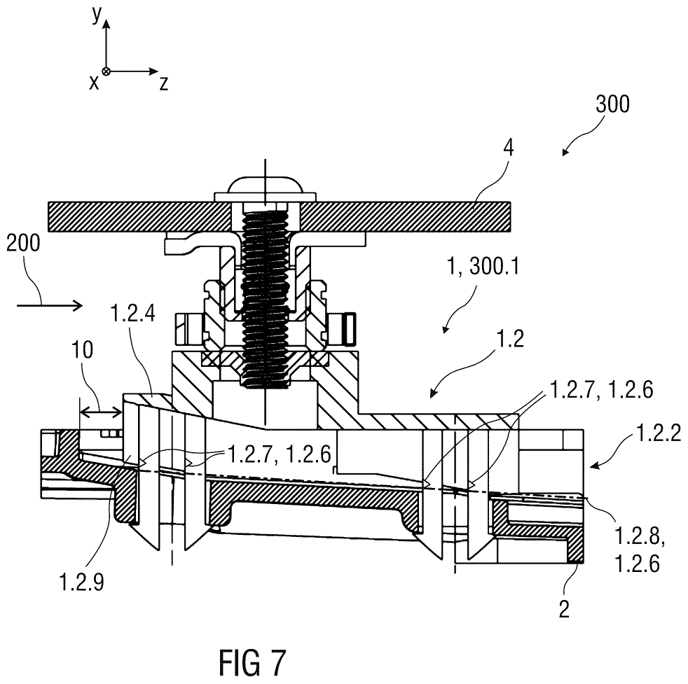

For example, as a result of an impact and the resulting force applied, in particular a minimum force that is applied, the second connection point 1.2.2 can be irreversibly separated, as shown in detail in FIG. 7. Additionally or alternatively, when a force is applied, the first component 2 can move at least to a limited extent in the application direction 200 relative to the other second component 4 and the tolerance compensation device 1.

In other words, in addition to the first connection point 1.2.1 between the tolerance compensation element 1.1 and the protective element 1.2, the tolerance compensation device 1 comprises the second connection point 1.2.2 between the protective element 1.2 and the first component 2.

The protective element 1.2 can be connected, on the one hand, to the tolerance compensation element 1.1 via the at least one first connection point 1.2.1 and, on the other hand, to the first component 2 via the at least one second connection point 1.2.2. By designing the second connection point 1.2.2 as a flexible connection, in particular one that can be moved and/or separated in a flexible manner, impact energy from a pedestrian in the application direction 200 can be reduced.

The protective element 1.2 is designed in particular as a single-piece component, in particular as an injection-molded component. The protective element 1.2 comprises a base unit 1.2.4. The base unit 1.2.4 can be designed, for example, as a base plate or a base disk.

The first connection point 1.2.1 projects vertically from the base unit 1.2.4 in one direction, in particular in the direction of the tolerance compensation element 1.1, and the second connection point 1.2.2 projects vertically in the opposite direction, in particular in the direction of the first component 2.

The first connection point 1.2.1 is designed, for example, as a fixed bushing 1.2.4.1 comprising the receptacle 1.2.3 for the retaining element 1.1.2, in particular for a latching arm comprising a latching hook, of the tolerance compensation element 1.1.

The second connection point 1.2.2 is of a flexible design. The second connection point 1.2.2 can, for example, comprise a plurality of flexible retaining arms 1.2.5, in particular flexible latching arms with latching hooks or clip arms with clip hooks.

The protective element 1.2 can comprise, as the first connection point 1.2.1, a plurality of receptacles 1.2.3, in particular two opposite receptacles 1.2.3 for the retaining elements 1.1.2, as shown in FIG. 2.

In addition, the protective element 1.2 can have a plurality of second connection points 1.2.2, each of which comprises a plurality of retaining arms 1.2.5, in particular an even numbered plurality of retaining arms 1.2.5, which form a group. The second connection points 1.2.2 and the groups of retaining arms 1.2.5 are symmetrically distributed over the base unit 1.2.4. For example, in a rectangular base unit 1.2.4, the second connection points 1.2.2 are each arranged in one of the corners.

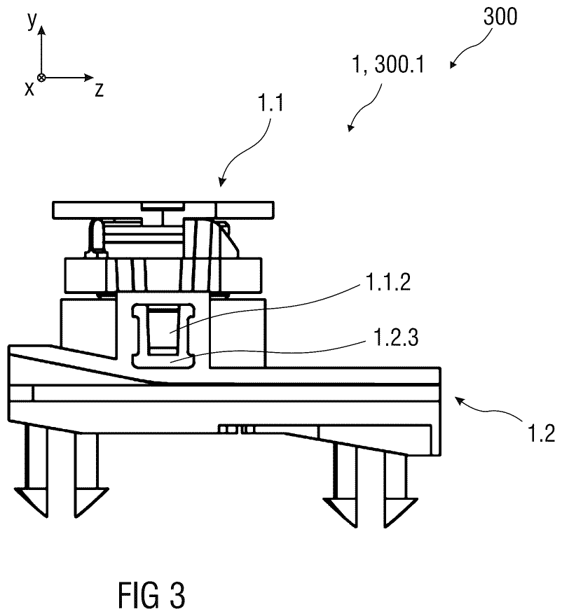

FIG. 3 is a schematic side view of the tolerance compensation device 1 in the assembled or connected state, for example in a delivery state in which all components of the tolerance compensation device 1 are captively connected to one another.

In the assembled state, the retaining elements 1.1.2, in particular latching hooks or latching clamps, of the tolerance compensation element 1.1 are arranged and held in a friction-locking and/or positive locking manner in the receptacles 1.2.3 of the protective element 1.2.

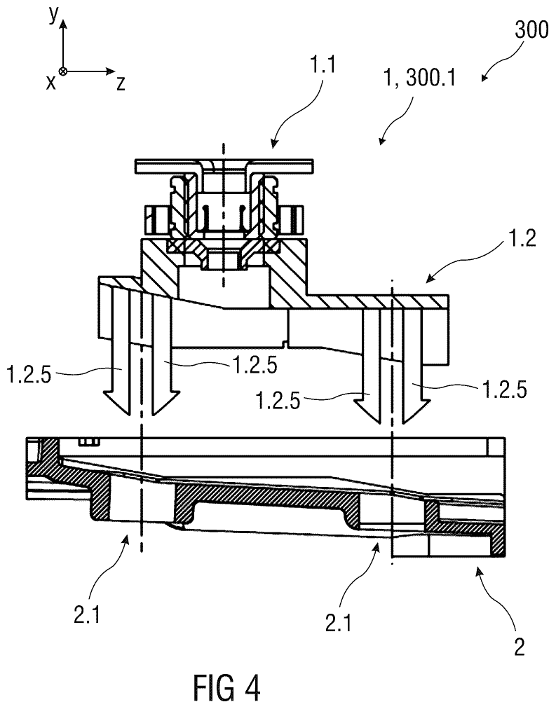

FIG. 4 shows a schematic sectional exploded view of the tolerance compensation device 1 before being mounted on the first component 2. The first component 2 can be, for example, a headlight, in particular a front headlight.

The first component 2 comprises openings 2.1 for receiving the retaining arms 1.2.5 of the protective element 1.2. In particular, the first component 2 comprises a number of openings 2.1 corresponding to the number of groups of retaining arms 1.2.5 for a pre-mounting and pre-positioning of the tolerance compensation device 1 on the first component 2.

The openings 2.1 are designed, for example, as through-openings. The openings 2.1 are in particular designed such that when the retaining arms 1.2.5 are inserted, the tolerance compensation device 1 and the first component 2 are mounted and held so as to have limited movement relative to one another, in particular limited radial and/or axial movement. For example, to allow axial mobility, the retaining arms 1.2.5 are longer than the length of the openings 2.1. To allow limited radial mobility, the openings 2.1 are designed to be larger than an outer circumference of the retaining arms 1.2.5 inserted into the respective openings 2.1.

The retaining arms 1.2.5 are designed, for example, as latching arms or clip arms and comprise a latching hook or clip hook at the free end. The tolerance compensation element 1.1, which is pre-assembled with the protective element 1.2 in particular rigidly connected thereto, and thus the tolerance compensation device 1, is clipped into the openings 2.1 of the first component 2 by means of the retaining arms 1.2.5, in particular arranged and held in a force-locking manner and with limited movement, in particular with limited axial and/or radial movement.

In other words: the first component 2 is arranged so as to be movable relative to the tolerance compensation device 1, or vice versa, and is connected thereto.

FIG. 5 shows a schematic sectional exploded view of the tolerance compensation device 1 mounted on the first component 2 and before the mounting of a second component 4 on the tolerance compensation device 1.

The second component 4 is rigid and is, for example, a vehicle skin or a vehicle panel.

The second connection point 1.2.2 between the tolerance compensation device 1 and the first component 2 is designed as a clip connection or latching connection. Instead of a clip connection or latching connection consisting of retaining arms 1.2.5 and openings 2.1, other suitable loose connections, in particular a loose riveted connection, screw connections or the like, can also be provided.

In order to be flexible, the second connection point 1.2.2 can be designed as a connection having a gap 10 and the degree to which it is loose or mobile is limited, in particular being movable in regions (as shown in FIG. 7). The second connection point 1.2.2 may have a predetermined breaking point 1.2.6 in addition to the connection having limited looseness or limited mobility. The predetermined breaking point 1.2.6 is formed in particular in a contact region 1.2.8 between the protective element 1.2 and the first component 2. The predetermined breaking point 1.2.6 can, for example, be formed as a notch 1.2.7 in the corresponding retaining arm 1.2.5.

FIG. 6 is a schematic sectional view of the tolerance compensation device 1 when connected to the two components 2, 4 while compensating for axial tolerances 201 between these two components 2, 4. The tolerance compensation device 1, together with the components 2, 4, forms a pedestrian protection system 20 in the assembled final state, by means of which impact energy can be reduced.

In the connected state, a connecting element 6, in particular a bolt, is guided through a component opening 4.1 of the second component 4 and screwed into the tolerance compensation device 1, in particular into a nut element 8. The nut element 8 can be arranged and held rigidly, in particular in a rotationally fixed manner, in the base unit 1.2.4 of the protective element 1.2, in particular in the bushing 1.2.4.1. Alternatively, the nut element 8 can be designed as an integrated nut thread in the base unit 1.2.4 or as a nut element 8 overmolded in the base unit 1.2.4.

By tightening the connecting element 6, possible axial tolerance 201 with respect to the second component 4 is compensated for by means of the tolerance compensation device 1 and a rigid connection is created between these components 2 and 4.

FIG. 7 is a schematic sectional view of the tolerance compensation device 1 according to FIG. 6 with the flexible second connection point 1.2.2, which is formed between the first component 2 and the protective element 1.2 of the tolerance compensation device 1.

Not only the contact region 1.2.8, in particular a cross-sectional region between the component 2 and protective element 1.2, but also the notches 1.2.7 are flexible when a force acts in the application direction 200 and are optionally designed as predetermined breaking points 1.2.6.

When the tolerance compensation device 1 is combined or assembled with the protective element 1.2, a gap 10 (also called impact clearance) can be provided between the protective element 1.2, in particular between its base unit 1.2.4, and the first component 2, in particular a front headlight.

In the event of a collision or after a collision between a pedestrian and the first component 2 in the application direction 200, the force from the first component 2 acts on the second connection point 1.2.2, in particular on the contact region 1.2.8, so that the notches 1.2.7 designed as predetermined breaking points 1.2.6 break. As a result, the first component 2 moves in the application direction 200, in particular in the direction of a vehicle interior, until it strikes a stop 1.2.9 on the base unit 1.2.4 and compensates for the gap 10 (=a clearance).

In addition to the notches 1.2.7, cross-sectional surfaces of the first component 2 or other suitable surfaces or material reductions can be provided as predetermined breaking points 1.2.6 and designed accordingly.

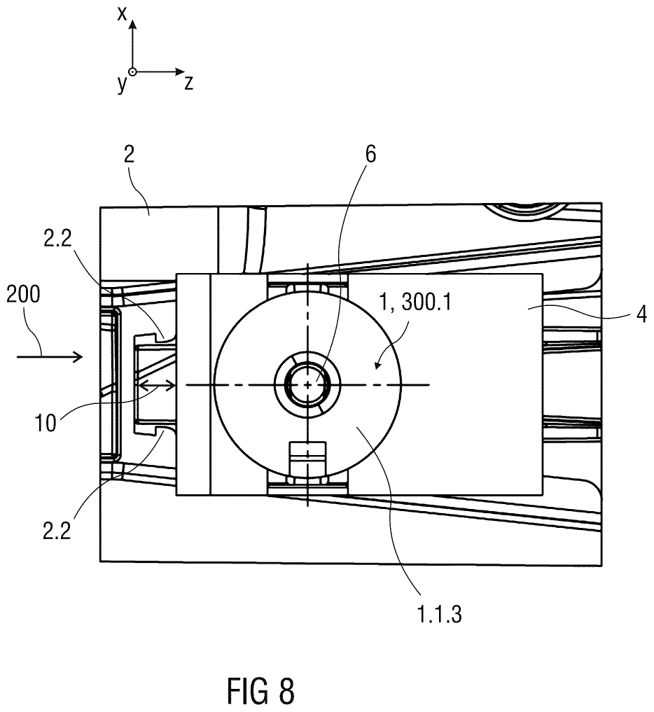

FIG. 8 is a schematic plan view of the tolerance compensation device 1 according to FIG. 6.

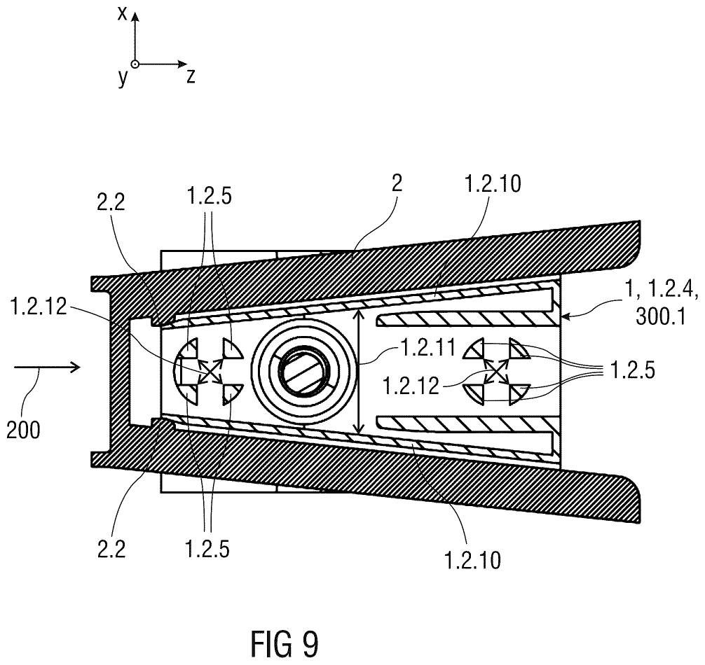

For a controlled reduction of the impact energy in the application direction 200, the first component 2 can have lateral constrictions 2.2. In the event of impact, these constrictions 2.2 slide through a guide 1.2.10 which is made in the base unit 1.2.4 of the tolerance compensation device 1, in particular of the protective element 1.2; shown in FIG. 9.

FIG. 9 shows a schematic sectional view through the first component 2 and the base unit 1.2.4 of the protective element 1.2, designed for example as a base plate, in the region of the lateral constrictions 2.2 of the first component 2 and the guides 1.2.10 in the base unit 1.2.4.

The guides 1.2.10 are designed, for example, as edges or shoulders in the base unit 1.2.4. The guides 1.2.10 extend in the application direction 200 and widen in the application direction 200. In other words, a distance 1.2.11 formed between the lateral guides 1.2.10 becomes larger in the application direction 200.

In each opening 2.1 in the first component 2, a group of four retaining arms 1.2.5 are arranged having a clearance 1.2.12, in particular a radial clearance 1.2.12, relative to one another. This clearance 1.2.12 serves in particular to provide flexibility for the retaining arms 1.2.5 such that they can be easily inserted into the opening 2.1 and held therein in a friction-locking and/or positive locking manner, in particular latched or clamped. In addition, this clearance 1.2.12 also serves to ensure the flexibility of the second connection point 1.2.2 in the event of impact against one of the components 2, 4 and, as a result, when a force is applied, for example in the application direction 200.

FIG. 10 is a schematic exploded view of a further embodiment of a connecting arrangement 300 having a connecting unit 300.1 designed as a tolerance compensation device 100 (hereinafter referred to as further tolerance compensation device 100).

The further tolerance compensation device 100 differs from the tolerance compensation device 1 in the type and shape of the second connection point 1.2.2 and of the base unit 1.2.4. Instead of the retaining arms 1.2.5 of the previously described second connection point 1.2.2, a second connection point 100.2.2 of the further tolerance compensation device 100 has a connecting bolt 100.2.5 for connecting a protective element 100.2 and the first component 2. Instead of notches 1.2.7 and contact regions 1.2.8 as predetermined breaking points 1.2.6, the further tolerance compensation device 100 has material reductions 100.2.7 in the protective element 100.2 as predetermined breaking points 100.2.6.

The tolerance compensation element 1.1 is analogously formed, as previously described, from the base element 1.1.1 and the compensation element 1.1.3 as well as the retaining elements 1.1.2. The first connection point 1.2.1 is analogously formed, as previously described, from the retaining elements 1.1.2 and the receptacles 100.2.3. The tolerance compensation element 1.1 can be pre-assembled and pre-fastened to the protective element 1.2 or 100.2 in a delivery state by means of the retaining elements 1.1.2 and thus captively held.

The modified second connection point 100.2.2 comprises a guide bush 100.2.13 for inserting the connecting bolt 100.2.5 and optionally for pre-mounting and pre-fastening and captive mounting of the connecting bolt 100.2.5 on the tolerance compensation device 100 in a delivery state.

The base unit 100.2.4 is designed, analogously to the base unit 1.2.4, as a plate or disk from which the two connection points 100.2.1 and 100.2.2 project vertically in opposite directions. To receive the tolerance compensation element 1.1, the base unit 100.2.4 analogously has a bushing 100.2.4.1.

Furthermore, the base unit 100.2.4 has a contact region 100.2.8 in the direction of the first component 2 for planar contact with the first component 2, analogously to the base unit 1.2.4.

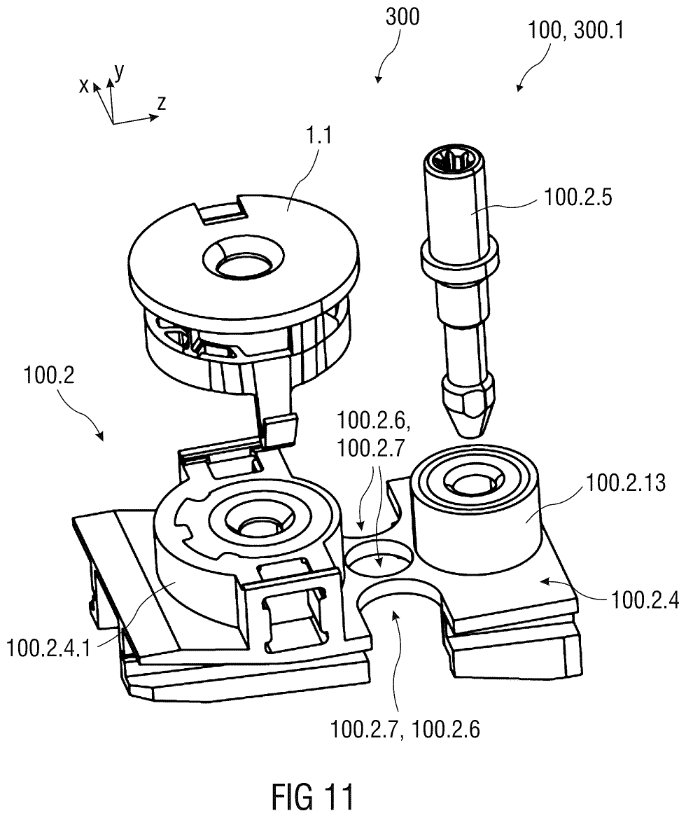

FIG. 11 schematically shows a perspective exploded view of the further tolerance compensation device 100 according to FIG. 10.

The base unit 100.2.4 has one or more predetermined breaking points 100.2.6 in the form of one or more material reductions 100.2.7 in a region between the bushing 100.2.4.1 and the guide bushing 100.2.13.

The material reduction 100.2.7 can, for example, take the form of a notch on the edge of the plate-shaped base unit 100.2.4. Additionally or alternatively, the material reduction 100.2.7 can take the form of a perforation and/or through-openings.

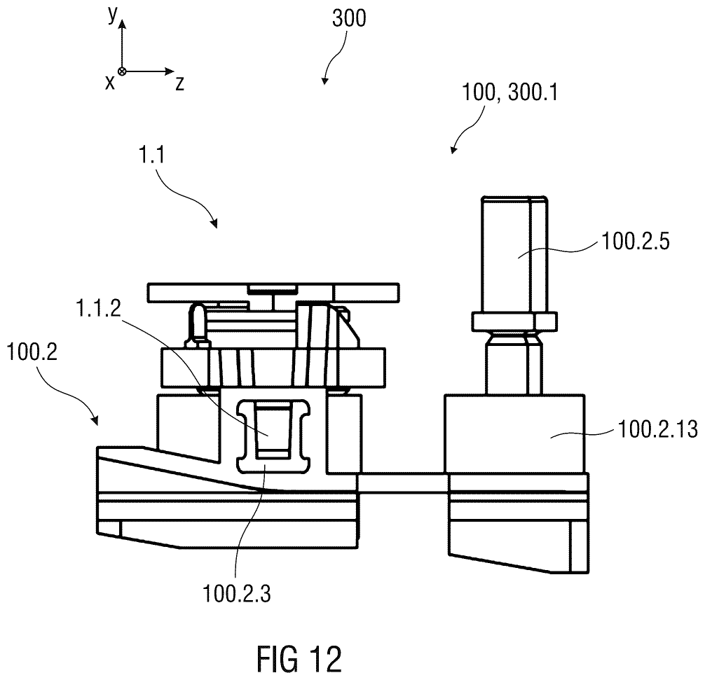

FIG. 12 is a schematic side view of the further tolerance compensation device 100 according to FIG. 10 in the assembled, in particular pre-assembled, state, for example in a delivery state in which all components of the tolerance compensation device 100 are captively connected to one another. The connecting bolt 100.2.5 is arranged and held captively in the guide bushing 100.2.13. The retaining elements 1.1.2 of the tolerance compensation element 1.1 are arranged in the receptacles 100.2.3 of the protective element 100.2 in a form-fitting and/or force-fitting manner and are rigidly fixed.

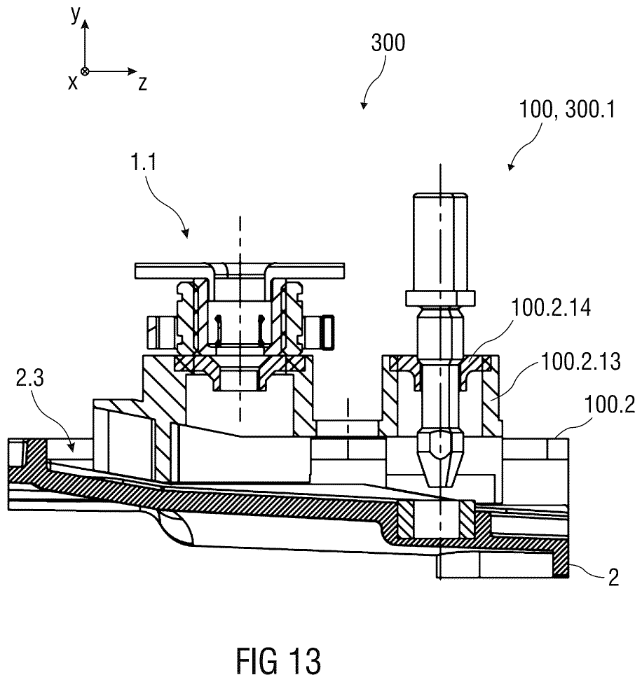

FIG. 13 is a schematic sectional view of the further tolerance compensation device 100 according to FIG. 12 pre-mounted on the first component 2. The tolerance compensation device 100 is placed on the first component 2 together with the tolerance compensation element 1.1 and the protective element 100.2. In particular, the tolerance compensation device 100 is inserted or pushed into a fastening receptacle 2.3 of the first component 2.

For pre-fastening the connecting bolt 100.2.5 in the guide bushing 100.2.13, said bolt comprises a retaining collar 100.2.14. The retaining collar 100.2.14 and the connecting bolt 100.2.5 have corresponding surfaces and/or surface contours, which create a releasable force-fitting and/or form-fitting connection.

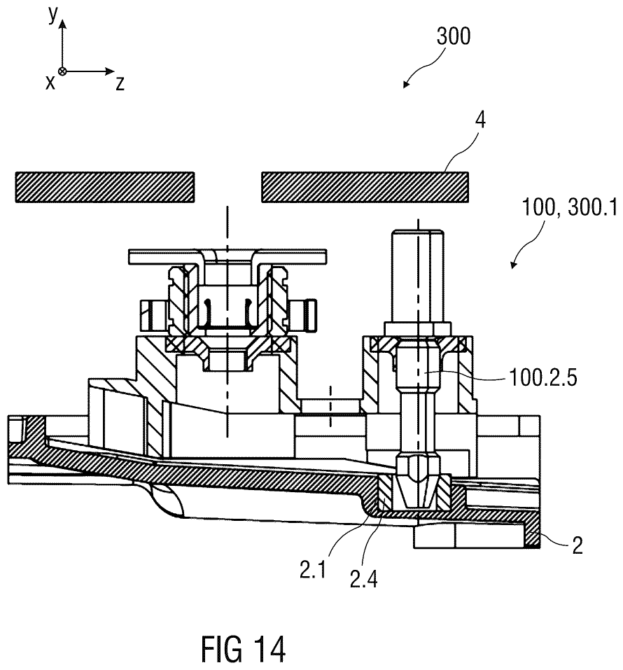

FIG. 14 is a schematic sectional exploded view of the tolerance compensation device 100 according to FIG. 12 pre-mounted on the first component 2 and before the mounting of the second component 4, in particular a solid or rigid component, such as a vehicle outer skin, on the tolerance compensation device 100.

For the pre-mounting and pre-fastening of the tolerance compensation device 100 on the first component 2, the connecting bolt 100.2.5 is screwed into a nut element 2.4, which is arranged in an opening 2.1 of the first component 2 such that it cannot rotate or is integrated therein, in particular overmolded.

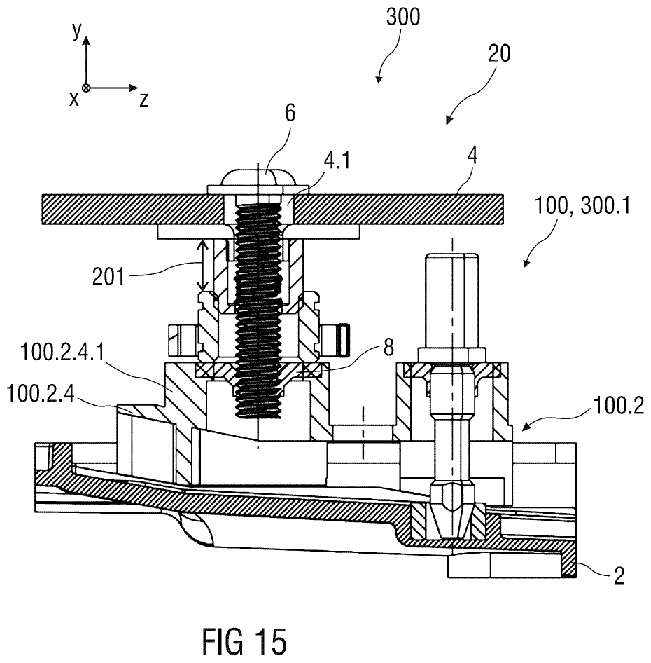

FIG. 15 is a schematic sectional view of the further tolerance compensation device 100 when connected to the two components 2, 4, thereby compensating for axial tolerances 201 between these two components 2 and 4. The tolerance compensation device 100, together with the components 2, 4, forms the pedestrian protection system 20 in the assembled final state, by means of which impact energy can be reduced.

In the connected state, the connecting element 6, in particular a bolt, is guided through the component opening 4.1 of the second component 4 and screwed into the tolerance compensation device 100, in particular into a nut element 8. The nut element 8 can be arranged and held rigidly, in particular in a rotationally fixed manner, in the base unit 100.2.4 of the protective element 100.2, in particular in the bushing 100.2.4.1. Alternatively, the nut element 8 can be designed as an integrated nut thread in the base unit 100.2.4 or as a nut element 8 overmolded in the base unit 100.2.4.

By tightening the connecting element 6, possible axial tolerance 201 with respect to the second component 4 is compensated for by means of the further tolerance compensation device 100 and a rigid connection is created between the components 2 and 4.

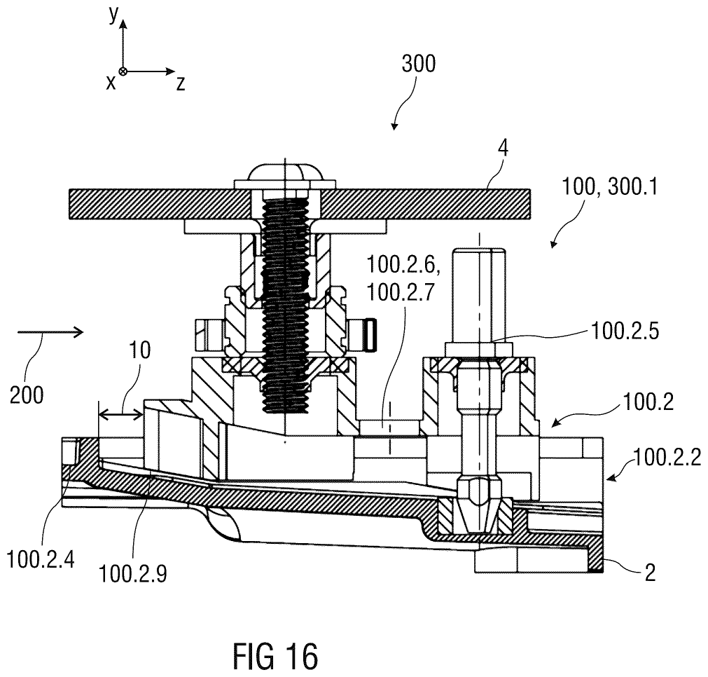

FIG. 16 is a schematic sectional view of the further tolerance compensation device 100 according to FIG. 15 comprising the flexible second connection point 100.2.2, which is formed between the first component 2 and the protective element 100.2.

In the state in which the tolerance compensation device 1 is combined or installed with the protective element 1.2, an analogous gap 10 (also called impact clearance) can be provided between the protective element 100.2, in particular between the base unit 100.2.4 thereof, and the first component 2, in particular a front headlight.

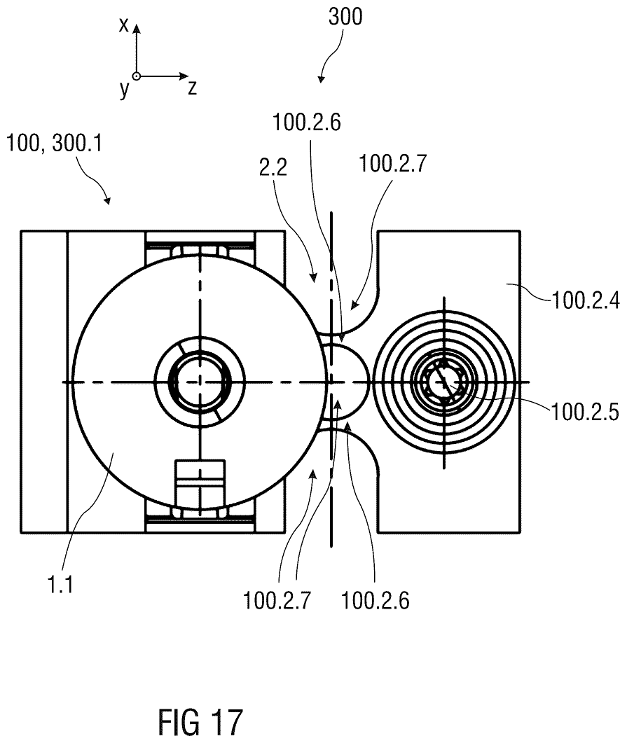

FIG. 17 is a schematic plan view of the further tolerance compensation device 100 according to FIG. 16 with constrictions 2.2 or material reductions 100.2.7 as predetermined breaking points 100.2.6 in the base unit 100.2.4 of the protective element 100.2 designed as a base plate; the second component 4 having been omitted for a better overview.

In the event of a collision or after a collision between a pedestrian and the first component 2 in the application direction 200, the force from the first component 2 acts on the second connection point 100.2.2, in particular on the connecting bolt 100.2.5, so that the material reductions 100.2.7 designed as predetermined breaking points 100.2.6 break. As a result, the first component 2 moves in the application direction 200, in particular in the direction of a vehicle interior, until it strikes a stop 100.2.9 of the base unit 100.2.4 and compensates for the gap 10 (=a clearance).

Other suitable surfaces or material reductions in the base unit 100.2.4 and/or on the connecting bolt 100.2.5 may also be provided as predetermined breaking points 100.2.6 and designed accordingly.

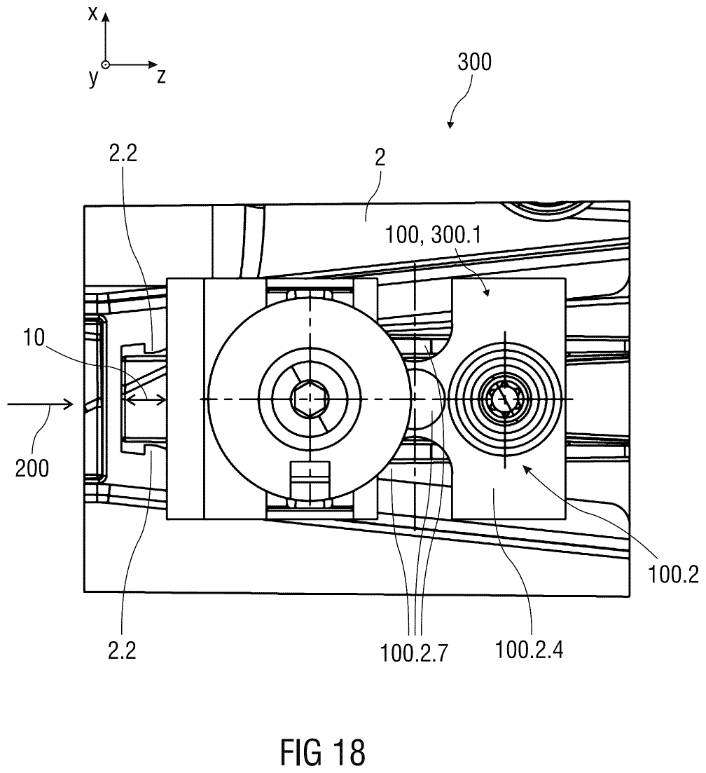

FIG. 18 is a schematic plan view of the further tolerance compensation device 100 according to FIG. 17 comprising the material reductions 100.2.7 in the protective element 100.2, in particular in the base unit 100.2.4.

For the controlled reduction of the impact energy in the application direction 200, the first component 2 can have the lateral constrictions 2.2 in a similar way to the tolerance compensation device 1. In the event of an impact, these constrictions 2.2 slide through a guide 100.2.10 made in the base unit 100.2.4 of the further tolerance compensation device 100, in particular of the protective element 100.2, as shown in FIG. 19.

FIG. 19 is a schematic sectional view through the first component 2 and the base unit 100.2.4 of the protective element 100.2, designed for example as a base plate, in the region of the lateral constrictions 2.2 of the first component 2.

The guides 100.2.10 are designed in an analogous manner to the first embodiment, for example as edges or shoulders in the base unit 100.2.4. The guides 100.2.10 extend in the application direction 200 and widen in the application direction 200. In other words: a distance 100.2.11 formed between the lateral guides 100.2.10 becomes larger in the application direction 200.

The connecting bolt 100.2.5 is screwed into the opening 2.1 in the first component 2.

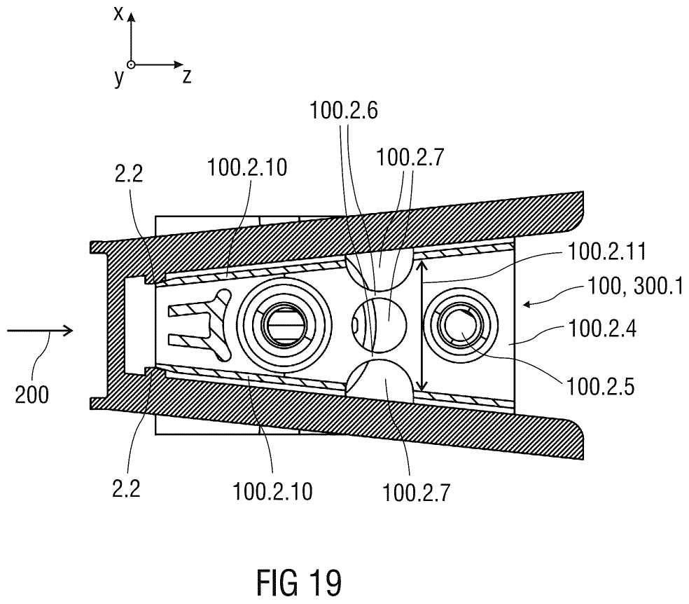

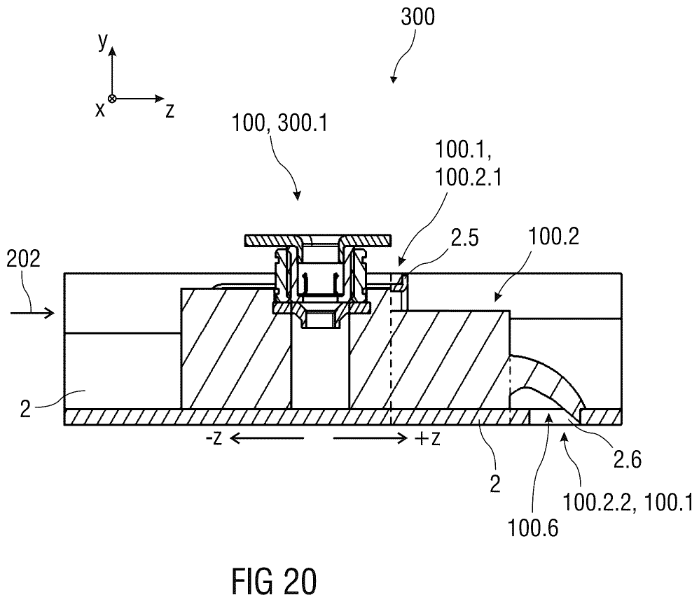

FIGS. 20 to 28 show different schematic representations of an embodiment of a connecting arrangement 300 having a connecting unit 300.1 designed as a tolerance compensation device 100 having a protective element 100.2 having a reversibly releasable separation point 100.1.

FIG. 20 shows a protective element 100.2 braced in the component 2.

The tolerance compensation device 100 differs from the above-described tolerance compensation devices 1, 100 in that the connection points 100.2.1 and 100.2.2 are reversibly releasable.

This may make it possible to reuse the components 2, 4. Likewise, the protective element 100.2 can be reusable. For a better overview, only component 2 is shown. Component 4 is fastened to the tolerance compensation device 100 as shown in FIG. 6.

The protective element 100.2 is designed as a slide 100.3. The protective element 100.2 comprises releasable connections, in particular releasable latching connections, as connection points 100.2.1 and 100.2.2.

The protective element 100.2 comprises, for example, a first stop element 100.4 and a second stop element 100.5. The two stop elements 100.4 and 100.5 are designed, for example, as flexible arms, in particular as spring arms. The two stop elements 100.4 and 100.5 act in opposite directions.

The first stop element 100.4 acts in the spatial direction −z. The second stop element 100.5 acts in the spatial direction +z. Alternatively, a stop can be provided in a manner not shown in detail, which stop acts in both spatial directions +z, −z and secures them.

In the event of mechanical stress according to arrow 202, for example impact, on the first component 2, for example on a headlight, the slide 100.3 moves in the spatial direction +z, since the first stop element 100.4 can disengage from a latching receptacle 2.5 on the component 2 and is released. As a result, the slide 100.3 can move by the clearance 100.6 in the spatial direction +z due to the flexible second stop element 100.5 and existing clearance 100.6 in a further latching receptacle 2.6 of the component 2 for the second stop element 100.5.

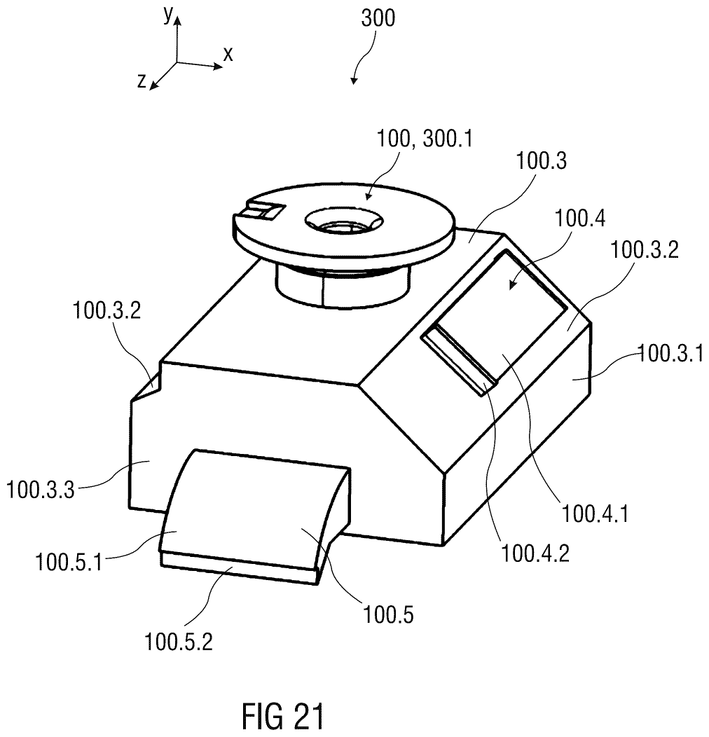

FIG. 21 shows the slide 100.3 comprising the pre-mounted tolerance compensation device 100.

The slide 100.3 has a rectangular base region 100.3.1 which is designed to guide the slide 100.3 during the compensating movement caused by the mechanical stress according to arrow 202. Above the base region 100.3.1, the slide 100.3 has inclined side walls 100.3.2, which are also designed to guide the slide 100.3 during the compensating movement and additionally to secure it against axially moving out thereof. The first stop element 100.4 is arranged on at least one of the side walls 100.3.2. The first stop element 100.4 projects outward from the side wall 100.3.2. The first stop element 100.4 is designed, for example, as a flexible latching arm 100.4.1 having a latching lug 100.4.2. The second stop element 100.5 is arranged on an end face 100.3.3. The second stop element 100.5 projects outward, in particular forward, from the end face 100.3.3. The second stop element 100.5 is designed, for example, as a flexible latching arm 100.5.1 having a latching lug 100.5.2.

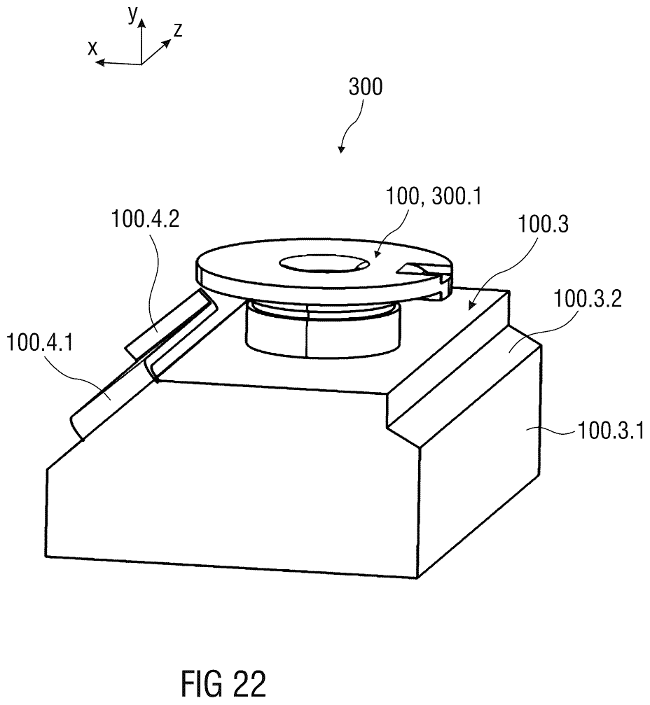

FIG. 22 shows the slide 100.3 in a perspective view from behind. The first stop element 100.4 is designed as a latching arm 100.4.1 inclined from the side wall 100.3.2.

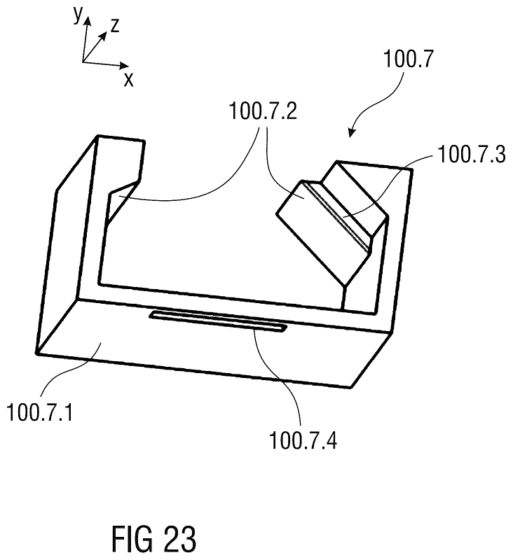

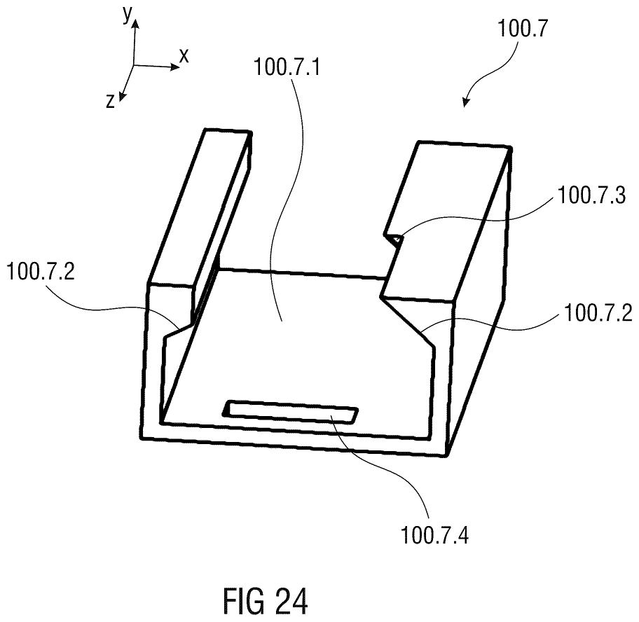

FIGS. 23 and 24 show a guide 100.7 provided for the slide 100.3, which is part of the first component 2, in particular is formed or arranged on the first component 2.

The guide 100.7 has a base surface 100.7.1 corresponding to the base region 100.3.1 of the slide 100.3. The guide 100.7 has side surfaces 100.7.2 corresponding to the inclined side walls 100.3.2 of the slide 100.3.

The guide 100.7 also has stop counter-elements 100.7.3 and 100.7.4 corresponding to the stop elements 100.4 and 100.5 of the slide 100.3. The first stop counter-element 100.7.3 is designed as a shoulder on an inner side of one of the side walls 100.3.2. A second stop counter-element 100.7.4 is formed as a slot in the base surface 100.7.1.

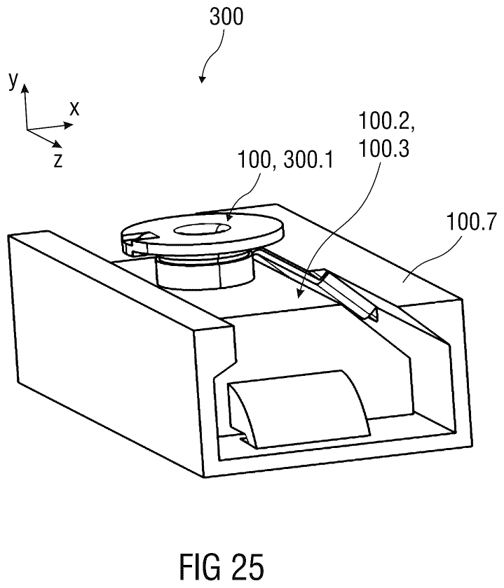

FIG. 25 shows the slide 100.3 with the pre-mounted tolerance compensation device 100 when mounted on the guide 100.7 of the first component 2.

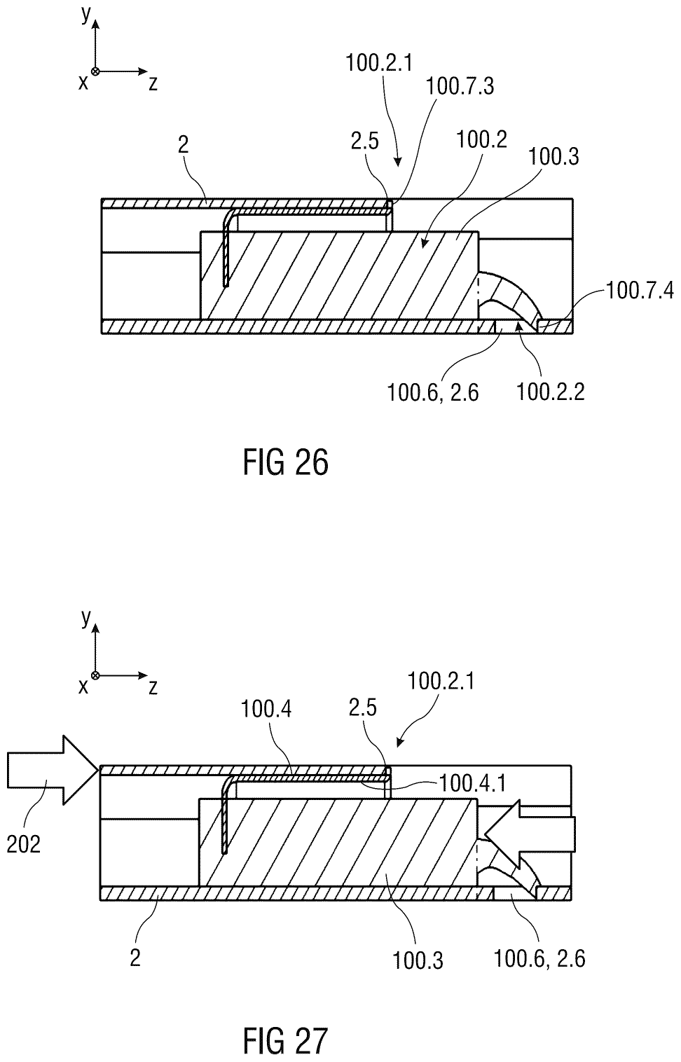

FIG. 26 shows the protective element 100.2 designed as a slide 100.3 fastened via the releasable connection points 100.2.1 and 100.2.2 between the stop counter-elements 100.7.3 and 100.7.4 of the component 2 and thus fastened to the component 2. Component 4 and the tolerance compensation device 100 are not shown.

FIG. 27 shows the component 2 subjected to a force according to arrow 202 as a result of mechanical stress, for example impact on the component 2. The first connection point 100.2.1 is releasable. The first stop element 100.4 is designed such that when a force acting on the component 2 according to arrow 202 exceeds a predetermined release force, it is released from the first connection point 100.2.1, in particular from the latching receptacle 2.5. As a result, the component 2 or, conversely, the slide 100.3 is released such that these can move relative to one another, in particular by the clearance 100.6 at the separation point 100.1, in particular in the latching receptacle 2.6.

The release force can, for example, be largely determined by the flexibility of the first stop element 100.4, in particular by a spring stiffness of the latching arm 100.4.1 and/or the contact angle of the stop element 100.4.

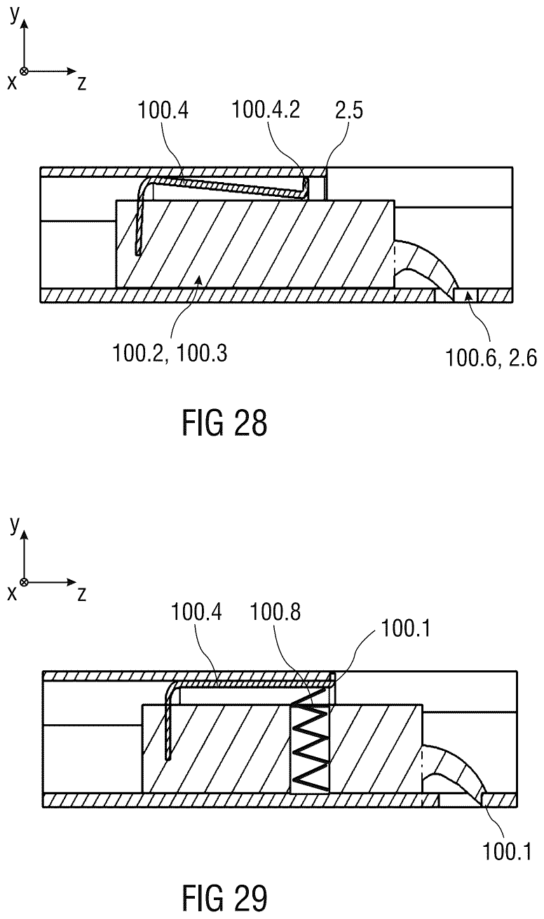

FIG. 28 shows the first stop element 100.4 in the released state, in which the latching lug 100.4.2 is released from the latching receptacle 2.5 and the component 2 is released. The second stop element 100.5 limits the relative movement of component 2 in the −z direction according to the clearance 100.6 in the latching recess 2.6.

FIGS. 29 to 33 show different schematic representations of an alternative separation point 100.1 of the connecting unit 300.1 designed as a tolerance compensation device 100.

FIG. 29 shows a pressure spring element 100.8, which can be provided in addition to or as an alternative to the flexible design of the latching arm 100.4.1. The release force is only partially determined by the spring force of the first stop element 100.4 or is not determined by said spring force but by the pressure force of the pressure spring element 100.8.

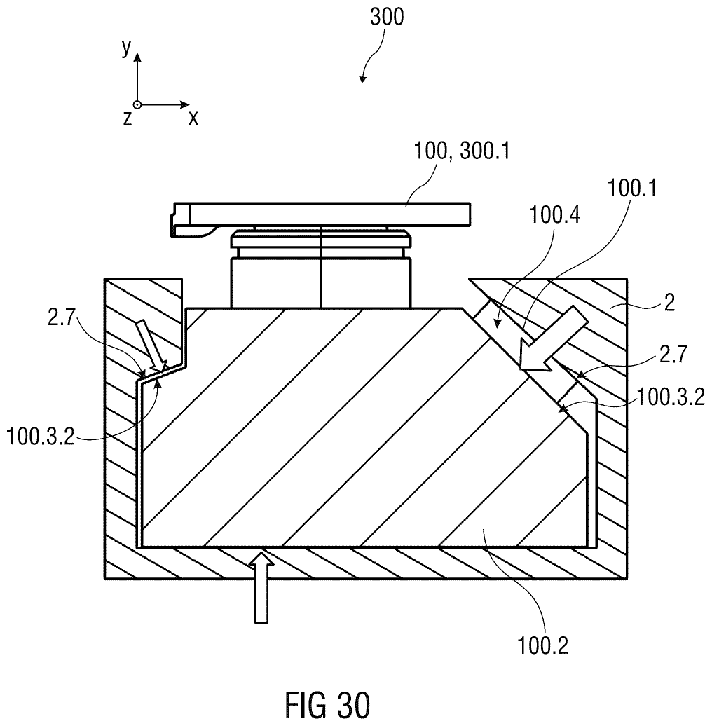

FIG. 30 shows the absence of clearance in the longitudinal direction x and in the transverse direction y of component 2 and the protective element 100.2 when fastened to one another, in particular in the braced and thus clearance-free state as a result of the flexible stop elements 100.4, 100.5. The protective element 100.2 is held braced in the component 2 by means of the flexible stop elements 100.4, 100.5 and the corresponding surfaces, in particular the inclined side walls 100.3.2 and inclined component walls 2.7, in particular in all three spatial directions x, y, z, in particular in the longitudinal direction x, in the transverse direction y and in the vertical direction z (shown in FIG. 20).

By means of the flexible stop elements 100.4, 100.5, the tolerance compensation device 100 can be held in the component 2 via the protective element 100.2 without clearance and thus with little movement up to a predetermined release force. This in particular prevents or at least reduces vibration of the component 2 when mounted, for example so-called headlight trembling in a component 2 designed as a headlight.

The flexible stop elements 100.4, 100.5 (shown in FIG. 20) generate a force that clamps the protective element 100.2 without clearance in the three spatial directions x, y, z.

In FIG. 30, the absence of clearance in the spatial direction x, y is created by the first stop element 100.4 introducing a force which has a Y component and an X component. In addition, the force being introduced is supported by the corresponding slopes of the side wall 100.3.2 and component wall 2.7.

The force to be introduced can be caused by the flexible first stop element 100.4. Alternatively, at least one separate spring element (not shown in detail), for example an arcuate leaf spring or the like, can also be provided for each of the spatial directions x, y, z.

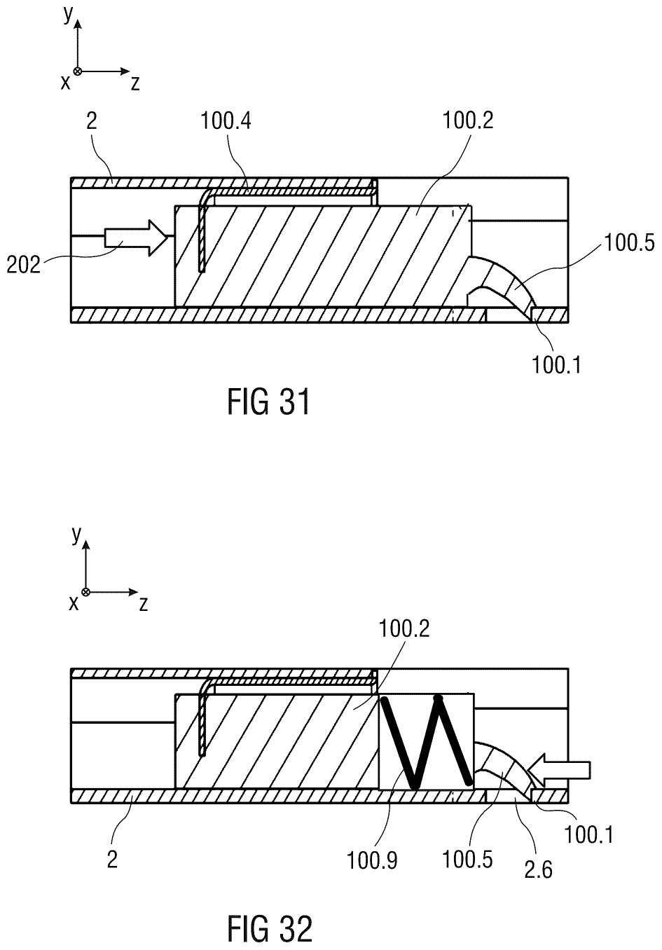

FIG. 31 shows the clearance-free braced arrangement of the protective element 100.2 in the spatial direction z by means of the second stop element 100.5. In order to clamp the slide 100.3 without clearance in the spatial direction z, the second stop element 100.5 is pre-tensioned (“over-pressed”) and fastened in the latching receptacle 2.6.

FIG. 32 shows a further embodiment relating to the absence of clearance or braced fastening in spatial direction z. In addition to the second stop element 100.5, a resilient element 100.9, in particular a disk spring or the like, is provided, which fastens the second stop element 100.5 in the latching receptacle 2.6 so as to be pretensioned by a predetermined force.

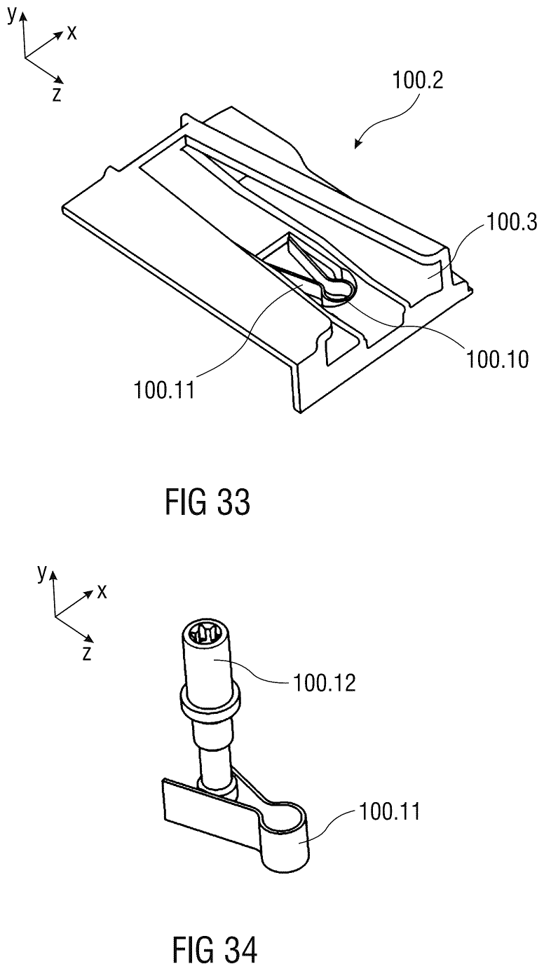

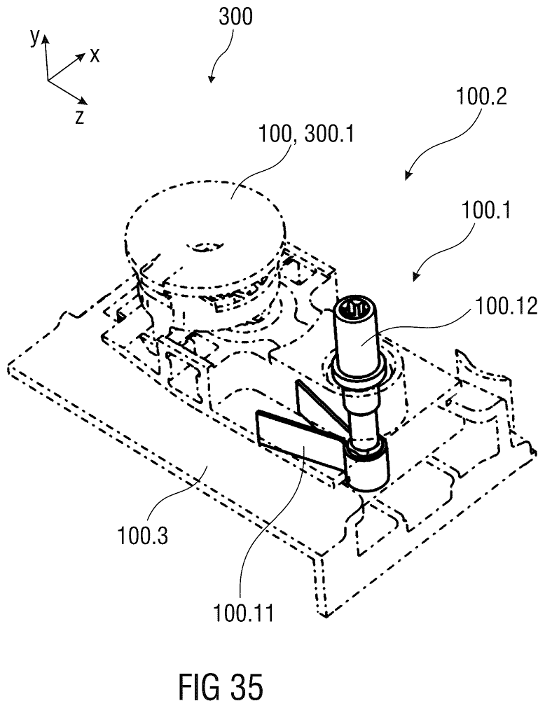

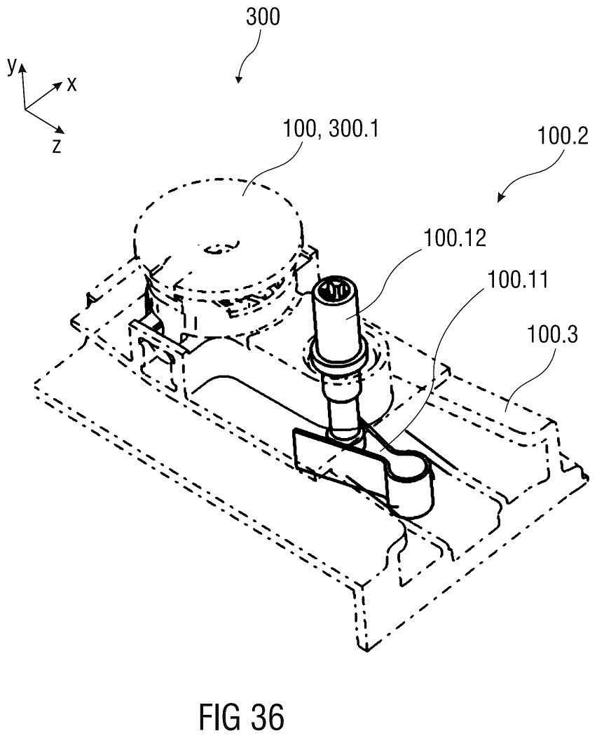

FIGS. 33 to 36 are different schematic representations of a further embodiment of a tolerance compensation device 100 comprising a protective element 100.2 with a reversible releasable separation point 100.1. The slide 100.3 has a recess 100.10 in which a retaining spring 100.11, in particular an omega spring (as shown in FIG. 33) is arranged for receiving a releasable retaining element 100.12, in particular a retaining bolt or retaining pin or the like (as shown in FIG. 34). FIG. 35 shows the protective element 100.2 in the normal position and thus in the connected position of the components 2 and 4, which are connected to one another via the tolerance compensation device 100 and the protective element 100.2 in a way that is free of clearance, in particular braced, and compensates for tolerances. FIG. 36 shows the protective element 100.2 in the triggered or released state following mechanical stress on the connection, wherein the separation point 100.1 has been reversibly released by releasing the retaining element 100.12 from being fastened in the retaining spring 100.11.

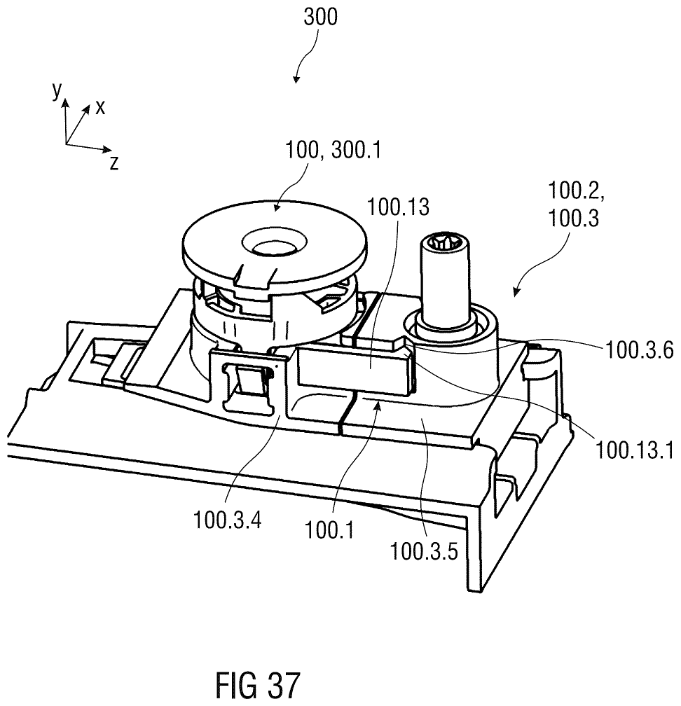

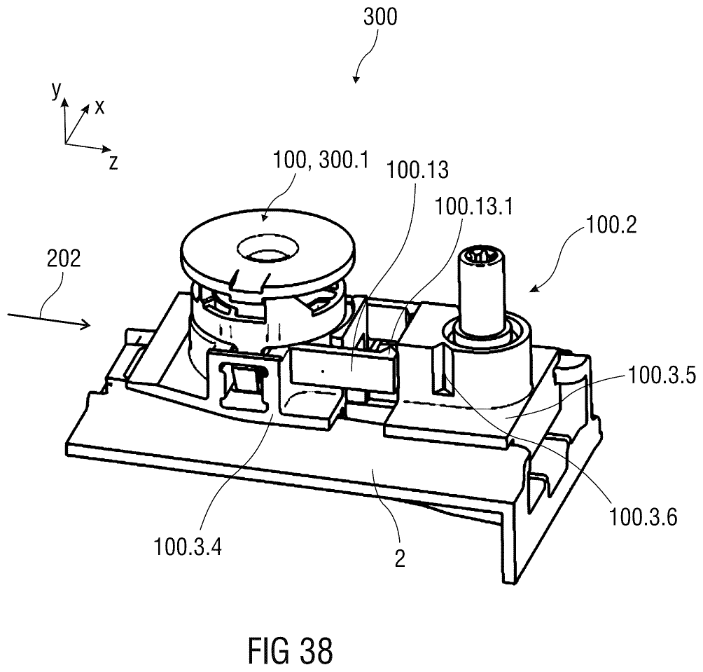

FIGS. 37 to 38 show different schematic representations of a further embodiment of a connecting arrangement 300 with a connecting unit 300.1 designed as a tolerance compensation device 100 having a protective element 100.2 having a reversible releasable separation point 100.1.

The protective element 100.2, in particular the slide 100.3, is made up of several parts, for example two parts. The separation point 100.1 is shown in FIG. 37 in the closed position and is formed between two slide parts 100.3.4 and 100.3.5. The separation point 100.1 comprises a retaining arm 100.13, which is immovably arranged on one of the slide parts 100.3.4 and is releasably fastened to the other slide part 100.3.5. For this purpose, the slide part 100.3.5 comprises, for example, a latching groove 100.3.6, in which a latching lip 100.13.1 of the retaining arm 100.13 releasably engages.

FIG. 38 shows the separation point 100.1 in the released position after mechanical stress has been applied to the component 2 according to arrow 202, which stress exceeds the retaining force of the retaining arm 100.13 in the latching groove 100.3.6, such that the retaining arm 100.13 is disengaged from the latching groove 100.3.6 and released, and the slide parts 100.3.4 and 100.3.5 move relatively away from one other.

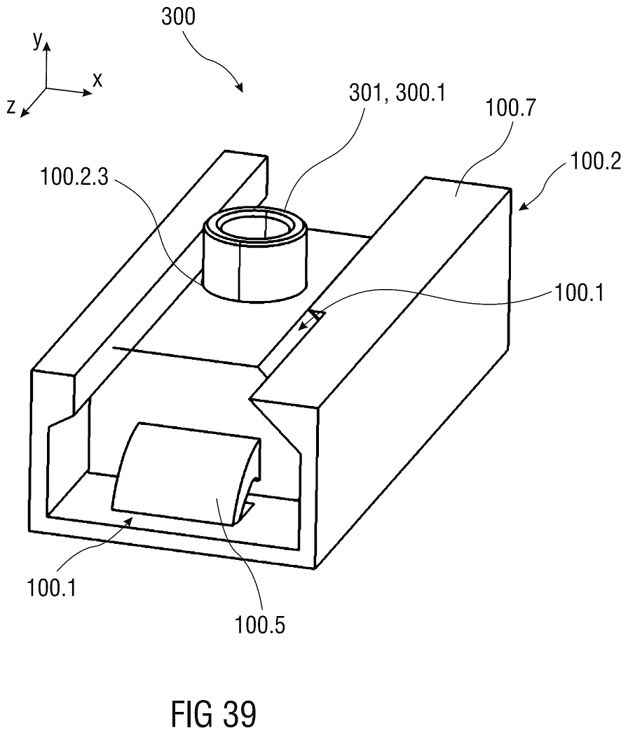

FIGS. 39 to 43 show different schematic representations of an embodiment of a device 300 for connecting at least two components 2, 4 (also called a connecting arrangement 300), comprising the previously described protective element 100.2 having the at least one reversibly releasable separation point 100.1.

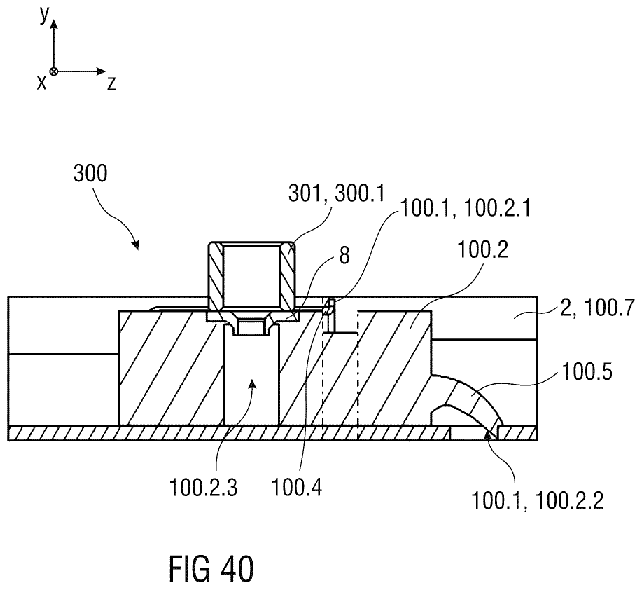

In FIGS. 39 and 40, the device 300 comprises a separate spacer element 301 as the connecting unit 300.1 instead of the tolerance compensation devices 1, 100. The spacer element 301 is designed as a hollow-cylindrical connecting bolt. The spacer element 301 is arranged and fastened in the receptacle 100.2.3 (1.2.3) of the protective element 100.2 (1.2) in a similar manner to the tolerance compensation device 100 (1). In addition, the nut element 8 having an internal thread is arranged in the receptacle 100.2.3 (1.2.3), as shown in FIG. 40. The functionality of reversibly fastening the protective element 100.2 at the at least two separation points 100.1 of the connection points 100.2.1 and 100.2.2 by means of the stop elements 100.4, 100.5 is designed analogously to the tolerance compensation device 100, as described above.

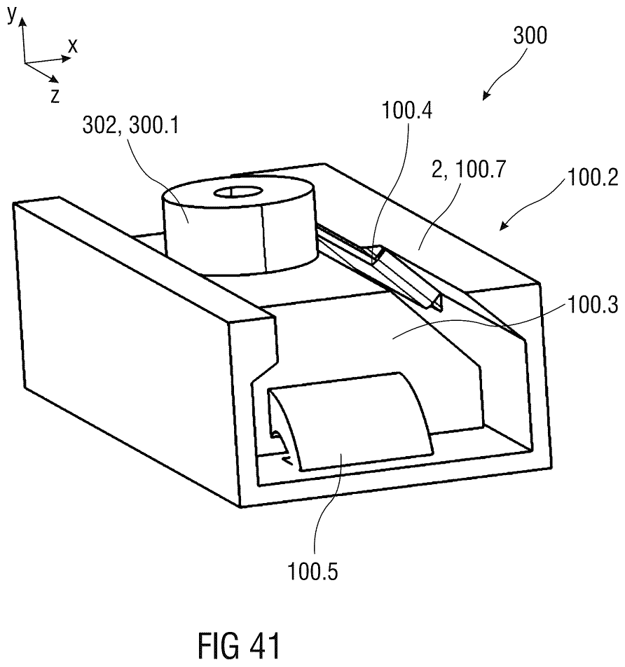

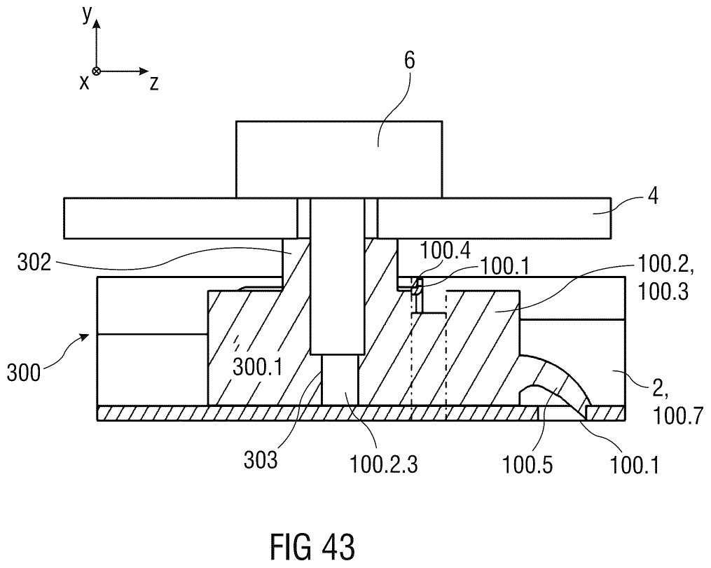

In FIGS. 41 to 43, the device 300 comprises an integrated distance extension 302 on the protective element 100.2 instead of a separate spacer element 301 as the connecting unit 300.1. Instead of the nut element 8, the receptacle 100.2.3 has an internal thread 303 for the connecting element 6, in particular a threaded screw or a threaded bolt. FIG. 43 shows the device 300 in the assembled state, in which, by means of the device 300 and the connecting element 6, the two components 2 and 4 are flexibly connected to one another at least in regions and/or at points by means of the protective element 100.2, in particular the slide 100.3 with the flexible stop elements 100.4, 100.5, in particular releasably connected via the separation points 100.1.

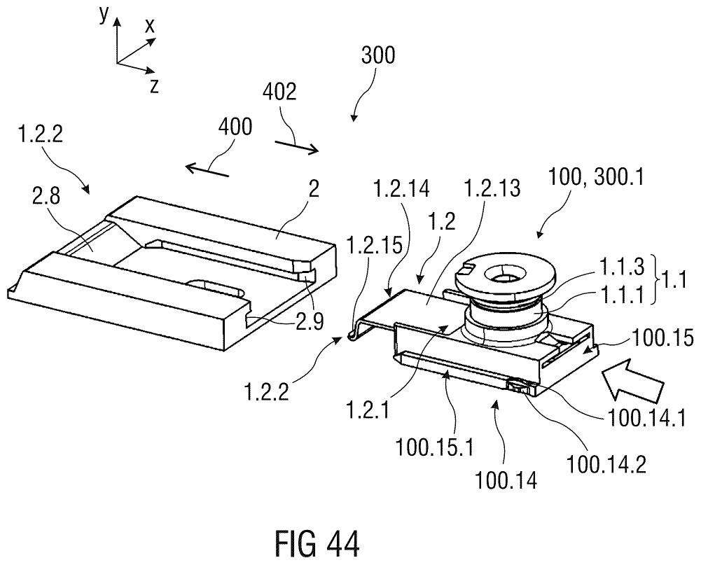

FIGS. 44 to 56 show different schematic representations of a further embodiment of a connecting arrangement 300 having a connecting unit 300.1 designed as a tolerance compensation device 100 for connecting the two components 2, 4.

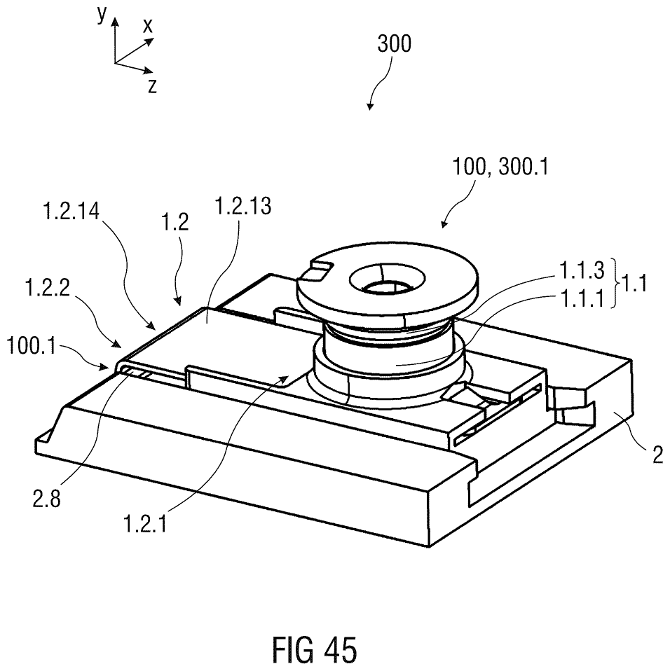

FIG. 44 shows the tolerance compensation device 100 in a partially exploded view and before being mounted on the component 2. FIG. 45 shows the tolerance compensation device 100 mounted on the component 2.

The tolerance compensation device 100 comprises the tolerance compensation element 1.1 and the protective element 1.2.

The tolerance compensation element 1.1 comprises at least the base element 1.1.1 and the compensation element 1.1.3, which is in threaded engagement with the base element 1.1.1 and which can move relative to the base element 1.1.1 by being rotated in order to compensate for tolerances.

The protective element 1.2 comprises at least the first connection point 1.2.1 having the tolerance compensation element 1.1 and at least the second connection point 1.2.2 having the component 2. In the present example, the second connection point 1.2.2 is designed to be flexible at least in some regions and/or at some points when a force is applied.

The second connection point 1.2.2 is designed as a reversible releasable separation point 100.1, as shown in FIG. 45.

Preferably, the component 2 and the protective element 1.2 are designed to be reversibly connected to one another in the region of the second connection point 1.2.2, in particular by clamping and/or snapping-in.

Alternatively or additionally, the tolerance compensation element 1.1 and the protective element 1.2 can be designed to be reversibly connected to one another in the region of the first connection point 1.2.1, in particular by clamping and/or snapping in (not shown in more detail).

For example, the protective element 1.2 can be designed as a spring plate 1.2.13. The component 2 has a ramp 2.8. Conversely, the protective element 1.2 can have a ramp 2.8 and portions of the component 2 can be designed as a spring plate 1.2.13 (not shown in more detail).

In particular, the protective element 1.2 is, on the one hand, rigidly arranged on the tolerance compensation element 1.1 and, on the other hand, can be releasably connected to the component 2.

For example, the protective element 1.2 has a snap-in element 1.2.15 or a clamping element at a free end 1.2.14. The snap-in element 1.2.15 is, for example, S-shaped (as shown) or hook-shaped or the like.

The ramp 2.8 can in particular be designed to correspond to the free end 1.2.14. For example, the ramp 2.8 can have a flatter rise in the connecting direction 400 than in the opposite opening direction 402. As a result, the protective element 1.2 can be reversibly latched to the ramp 2.8 in the connecting direction 400 by means of its snap-in element 1.2.15 or its clamping element. To release the second connection point 100.2.2, an opening force is required that overcomes the steeper rise of the ramp 2.8 and releases the snap-in element 1.2.15 or the clamping element from engagement with the ramp 2.8.

In addition, at least one compression rib 100.14 (shown in FIG. 44) can be provided for the clearance-free connection of the two components 2, 4. For example, a first compression rib 100.14.1, in particular an arcuate compression bridge, can extend in the vertical direction z in order to compensate for tolerances in the vertical direction z.

A second compression rib 100.14.2, in particular an arcuate compression bridge, can extend in the transverse direction y in order to compensate for tolerances in the transverse direction y. As a result, the tolerance compensation device 100 is mounted via the protective element 1.2 without clearance in at least two directions and is thus quietly mounted.

A mount 100.15 is provided for mounting the tolerance compensation device 100 on the component 2. The mount 100.15 is designed, for example, as a plinth. The mount 100.15 comprises a guide section 100.15.1, in particular two rail-shaped projections or two guide ribs. The component 2 correspondingly comprises a guide counter-section 2.9, in particular sliding grooves or undercuts, in which the rail-shaped projections are slidably mounted during assembly.

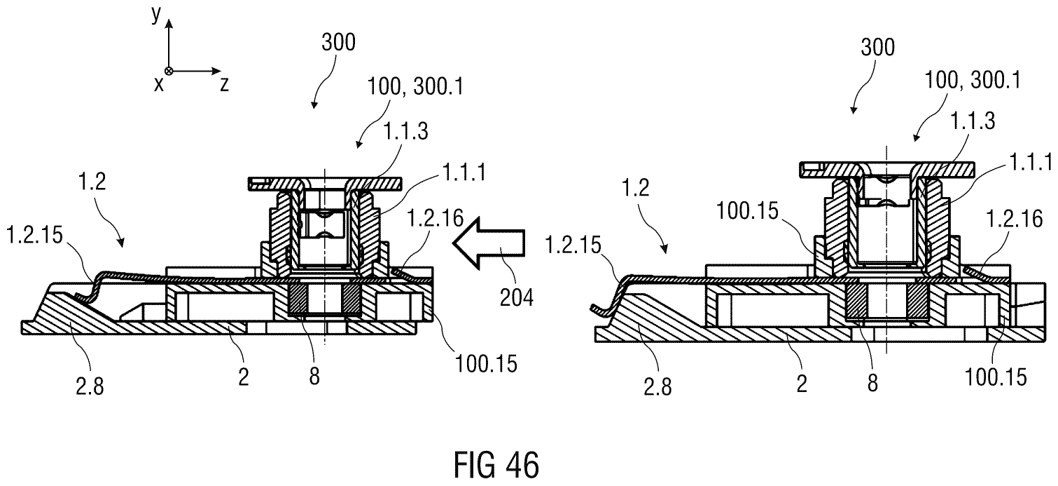

FIG. 46 shows the mounting of the tolerance compensation device 100 on the component 2.

The tolerance compensation device 100 is guided, in particular pushed, in the longitudinal direction x into the component 2 according to arrow 204 until the protective element 1.2, in particular the snap-in element 1.2.15 thereof, moves over the ramp 2.8 and engages therein, in particular snaps in, by latching thereto.

To fix the tolerance compensation device 100 in the longitudinal direction x according to arrow 204, the protective element 1.2 can comprise a stop 1.2.16, in particular a stop tongue or the like. The stop 1.2.16 extends diagonally upward from the protective element 1.2 and can come into contact with the mount 100.15.

The compression ribs 100.14 (also called compression elements) are formed in the region of the guide section 100.15.1, as shown in FIG. 44, and make possible a low-noise mounting and connection of the tolerance compensation device 100 and component 2.

The nut element 8 can additionally be integrated into the mount 100.15. Alternatively, an internal thread can be integrated.

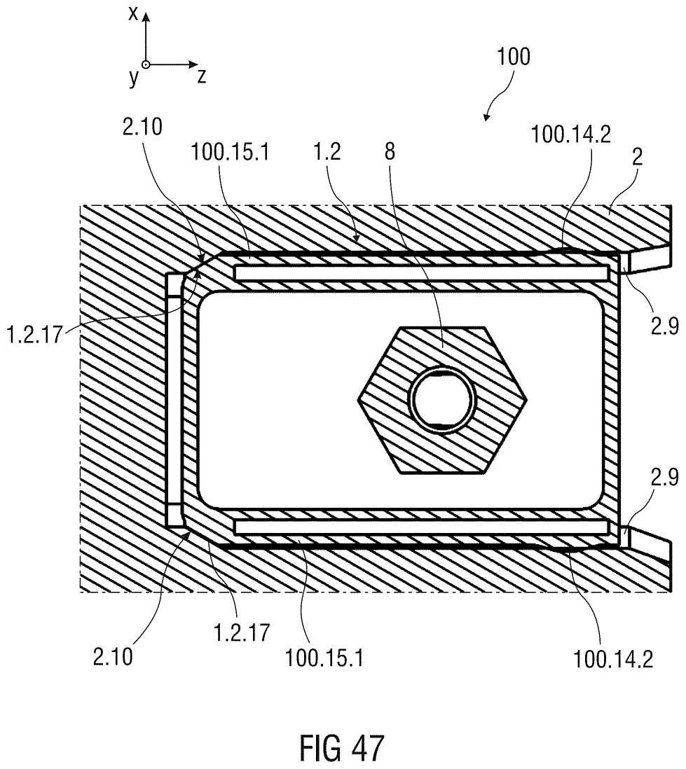

FIG. 47 shows the guide section 100.15.1, in particular the two lateral rail-shaped projections, of the mount 100.15. The component 2 correspondingly comprises the guide counter-sections 2.9, in particular sliding grooves or undercuts, in which the rail-shaped projections are slidably mounted during assembly.

By means of the second compression ribs 100.14.2, the protective element 1.2 and the tolerance compensation device 100 are held in the component 2 without clearance. The guide sections 100.15.1 can be designed as a hollow profile (as shown) or as a solid profile.

The nut element 8 is implemented in the center of the protective element 1.2.

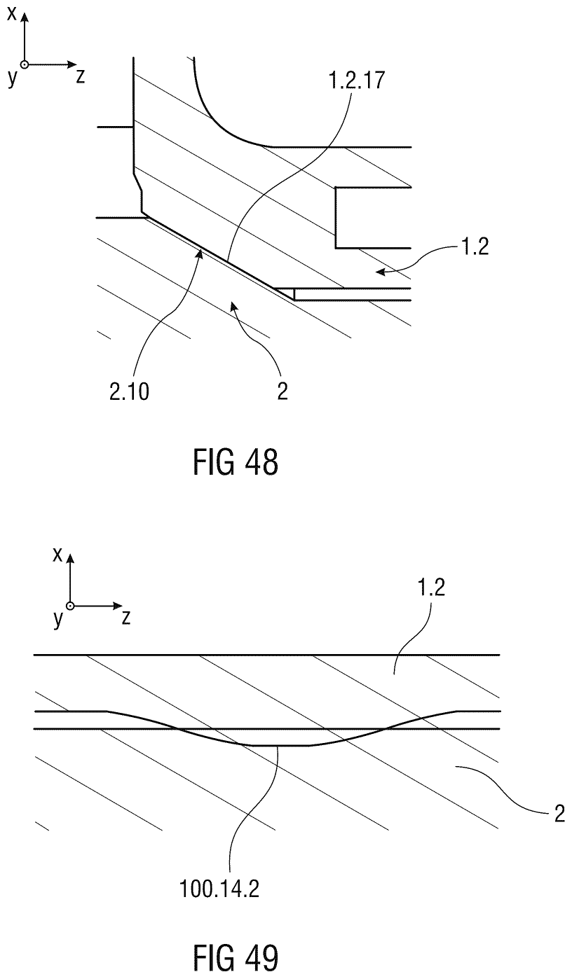

In addition, the protective element 1.2 can have beveled free ends 1.2.17 which, in the mounted end position, rest against counter-stops 2.10, as shown in FIGS. 47 and 48.

FIG. 49 shows how the protective element 1.2 and component 2 are rendered clearance-free by means of the second compression rib 100.14.2.

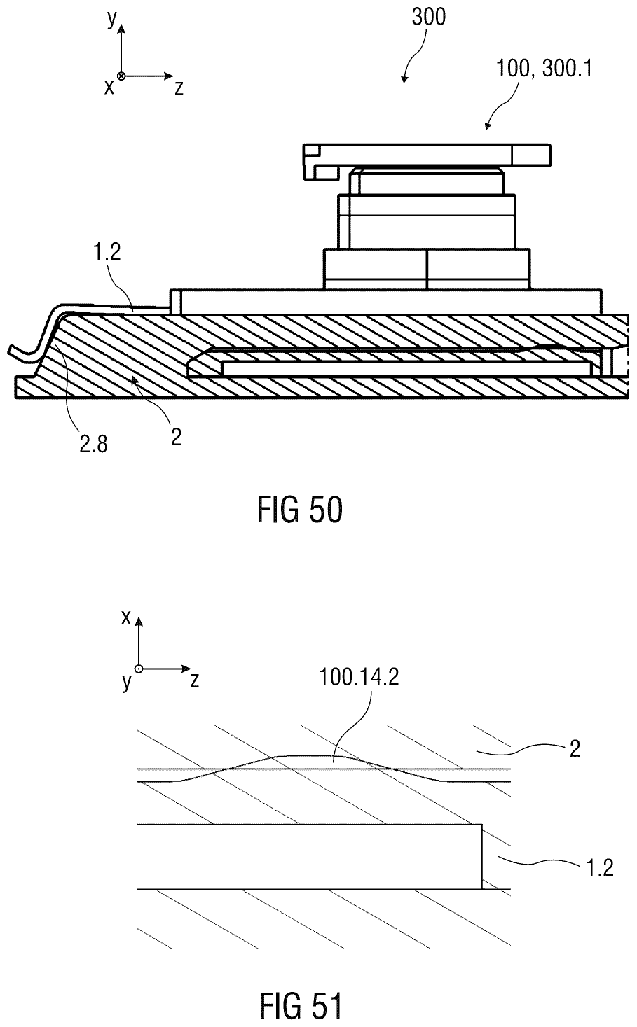

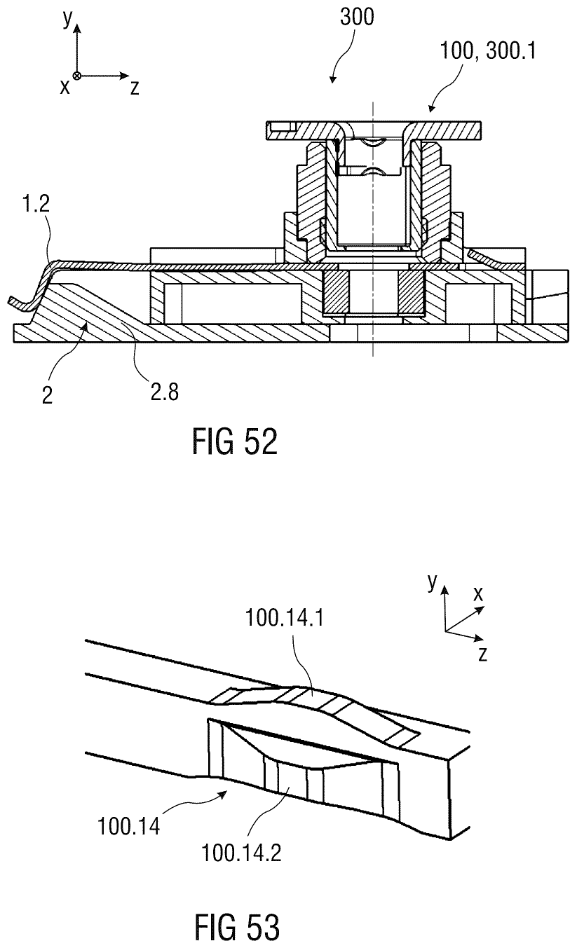

FIGS. 50 and 52 show two different sectional views of the tolerance compensation device 100 and component 2 in the assembled state, in which the protective element 1.2 reaches over the ramp 2.8 (FIG. 50) and engages behind it (FIG. 52).

FIGS. 51 and 53 show the compression ribs 100.14, in particular the first compression rib 100.14.1, which compensates for component tolerances in the vertical direction z, and the second compression rib 100.14.2, which compensates for component tolerances in the transverse direction y.

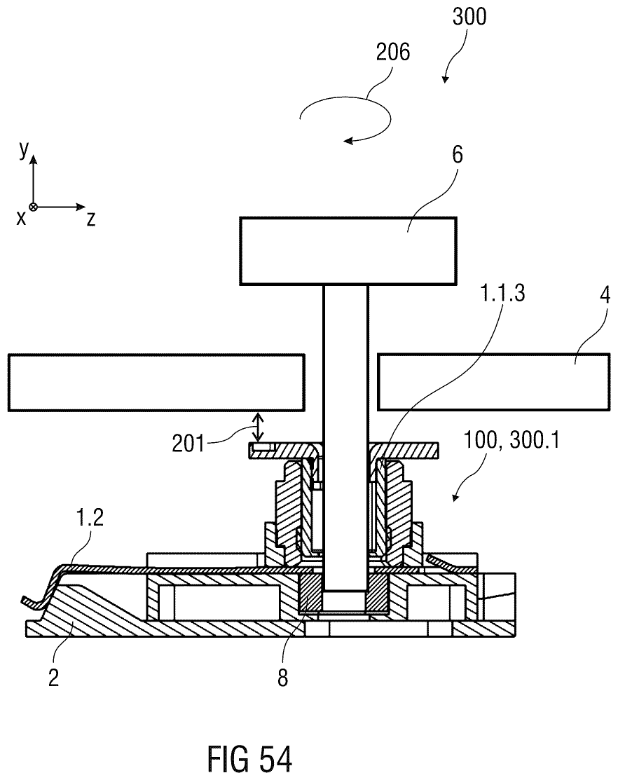

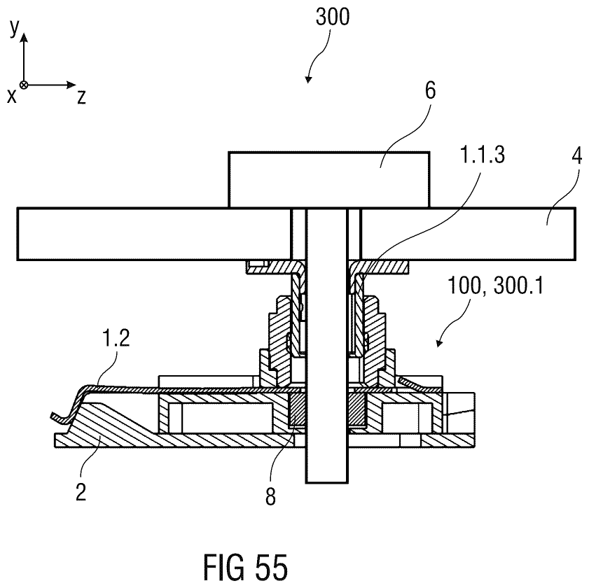

FIG. 54 shows the final assembly of the tolerance compensation device 100 pre-mounted on the component 2 with the protective element 1.2 on the other component 4 while compensating for axial tolerances 201 by means of the compensation element 1.1.3, as shown in FIG. 55. By tightening and screwing the connecting element 6 into the nut element 8 according to arrow 206, tolerances between the components 2 and 4 can be compensated for by means of the axially movable compensation element 1.1.3, as shown in FIG. 55.

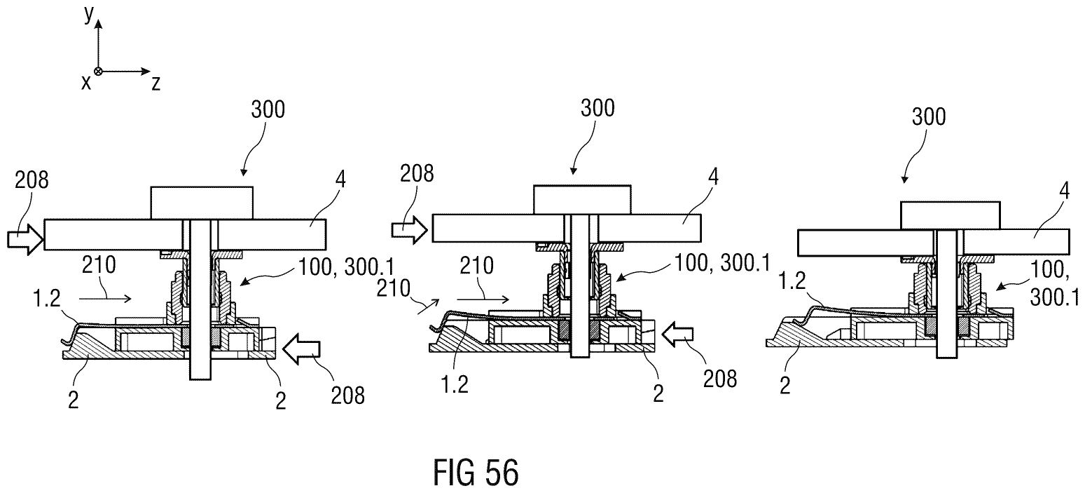

FIG. 56 shows the protective function provided by the protective element 1.2 as a movement sequence, in particular a possible movement of the protective element 1.2 according to arrow 210 in the event of a collision between a user and the component 2 or 4 according to arrow 208.

If a collision occurs according to arrow 208 between a pedestrian or another object and one of the components 2 or 4, a resulting impact energy on the component(s) 2, 4 can be reduced by the tolerance compensation device 100, in particular the protective element 1.2, disengaging from the ramp 2.8 and being able to move in the longitudinal direction x with or against the direction of impact according to arrow 210. By reducing the impact energy, pedestrian protection is achieved in a simple manner and injuries can be minimized.

FIGS. 57 to 58 schematically show a sectional view and a perspective view of a further connecting arrangement 300 for connecting at least two components 2, 4, comprising a protective element 1.2 with a reversible releasable separation point 100.1 and a connecting unit 300.1, comprising a compensation element 1.1.3 designed as a compression limiter and an integrated base element 1.1.1, which is formed in the second component 4 as an integrated internal thread 4.2 designed in particular as internal thread portions 4.2.1 of the second component 4.

The compensation element 1.1.3 has, for example, two groups of external thread portions 1.1.31, each extending in parallel with one another and distributed in the circumferential direction over its outer side.

The compensation element 1.1.3 has two hollow-cylinder halves 1.1.32 that are axially movable relative to one another. As a result, the compensation element 1.1.3 is designed as an axial compression limiter. A group of external thread portions 1.1.31 is provided on each hollow-cylinder half 1.1.32 of the compensation element 1.1.3. The external thread portions 1.1.31 are designed in such a manner that they form a multi-pitch threaded outer portion 12.3 of the compensation element 1.1. The pitch of the external thread portions 1.1.31 of the compensation element 1.1.3 can be adapted to the pitch of the internal thread 4.2 having internal thread portions 4.2.1 integrated on the inner wall of the second component 4. For example, the external thread portions 1.1.31 and the internal thread 4.2 form such a steep thread that the threaded engagement between the compensation element 1.1.3 and the second component 4 is not self-locking and has backlash.

The protective element 100.2 is designed, for example, as a spring plate 1.2.13 having a snap-in element 1.2.15 as a reversibly releasable separation point 100.1 at the free end 1.2.14. The snap-in element 1.2.15 forms the second point 100.2.2 where the protective element 100.2 connects to the first component 2. The first connection point 100.2.1 of the protective element 100.2 is designed as a rigid connection to the second component 4, in which the base element 1.1.1 is integrated as an internal thread 4.2.

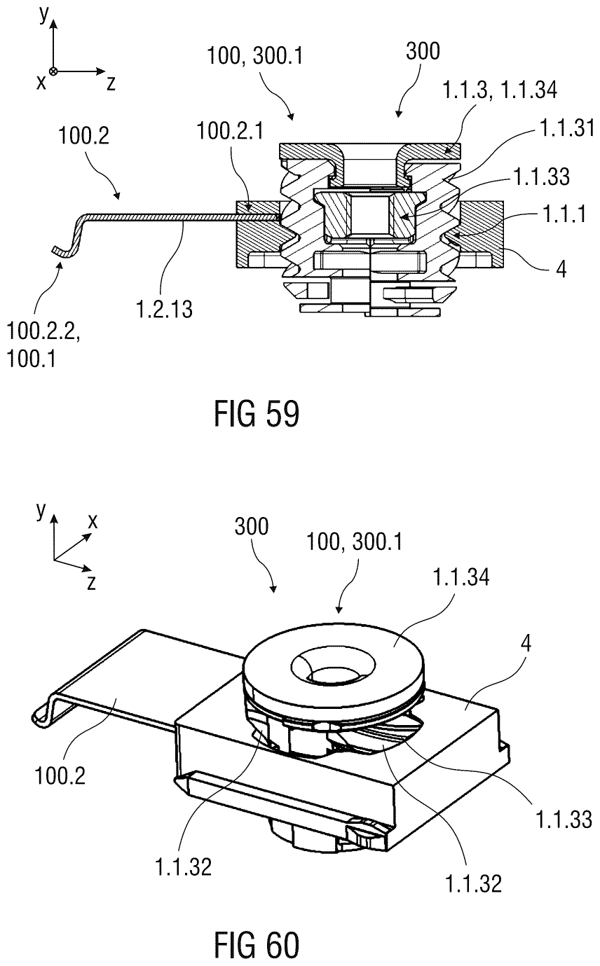

FIGS. 59 to 60 schematically show a sectional view and a perspective view of a further connecting arrangement 300 for connecting the two components 2, 4, having a protective element 1.2 with a reversibly releasable separation point 100.1 and a connecting unit 300.1 which comprises a compensation element 1.1.3 with an integrated nut element 1.1.33 and a base element 1.1.1 comprising an internal thread 4.2, which in turn forms the internal thread 4.2 of the second component 4.

The connecting arrangement 300 according to FIGS. 59 and 60 differs from the connecting arrangement 300 according to FIGS. 57 and 58 only in that the compensation element 1.1.3 comprises the integrated nut element 1.1.33. In addition, a washer 1.1.34 can be arranged on the outward-facing end face of the compensation element 1.1.3. The compensation element 1.1.3 is formed from two hollow-cylinder halves 1.1.32 which are axially movable relative to one another.

The protective element 100.2 is designed as a spring plate 1.2.13, analogously to FIGS. 57 and 58.

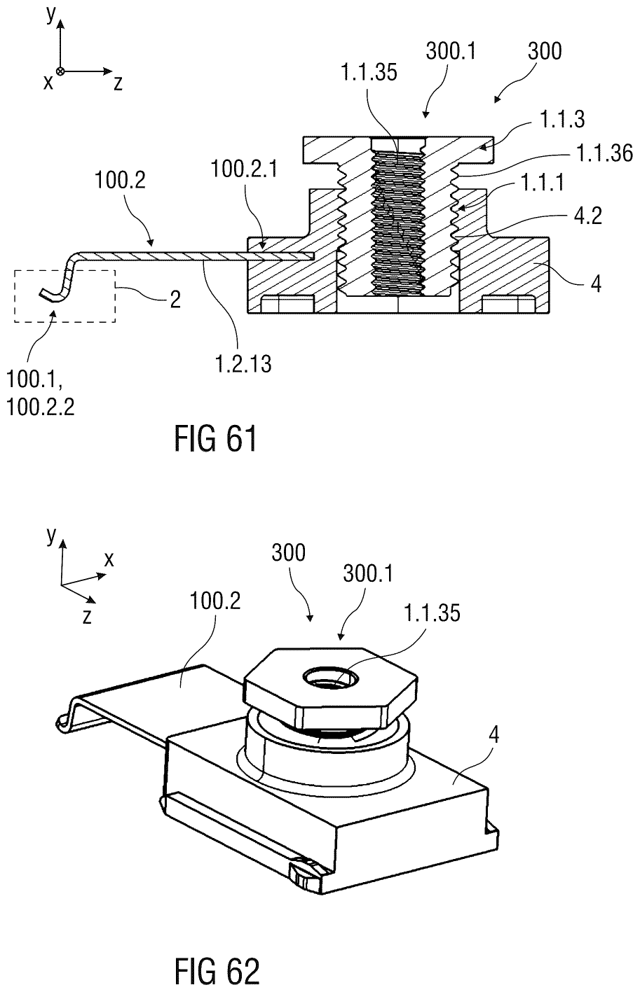

FIGS. 60 to 61 schematically show a sectional view and a perspective view of a further connecting arrangement 300 for connecting two components 2, 4, having the protective element 100.2 with a reversibly releasable separation point 100.1 as the second connection point 100.2.2 to the first component 2 and a connecting unit 300.1, comprising a simple compensation element 1.1.3 with an integrated internal thread 1.1.35 and metric external thread 1.1.36 and a base element 1.1.1 comprising an internal thread 4.2, which simultaneously forms the second component 4.

The connecting element 6 (shown in FIG. 6) can be screwed into the compensation element 1.1.3, as previously described.

The protective element 100.2 is designed as a spring plate 1.2.13 analogously to FIGS. 57 and 58, with the reversibly releasable separation point 100.1 as the second connection point 100.2.2.

FIG. 63 shows a schematic sectional view of a further connecting arrangement 300, having a protective element 100.2 designed as a spring plate 1.2.13 with a reversibly releasable separation point 100.1 as the second connection point 100.2.2 and a connecting unit 300.1 designed as a screw connection 300.2, comprising the connecting element 6, designed as a hollow bolt and optionally as a compensation element 1.1.3, and the base element 1.1.1 as an internal thread 4.2 of the second component 4.

### LIST OF REFERENCE SIGNS

1 Tolerance compensation device
1.1 Tolerance compensation element
1.1.1 Base element
1.1.2 Retaining member
1.1.3 Compensating element
1.1.31 External thread portion
1.1.32 Hollow-cylinder half
1.1.33 Integrated nut element
1.1.34 Washer
1.1.35 Integrated internal thread
1.1.36 External thread
1.2 Protective element
1.2.1 First connection point
1.2.2 Second connection point
1.2.3 Receptacle
1.2.4 Base unit
1.2.4.1 Bushing
1.2.5 Retaining arm
1.2.6 Predetermined breaking point
1.2.7 Notch
1.2.8 Contact region
1.2.9 Stop
1.2.10 Guide
1.2.11 Distance
1.2.12 Clearance
1.2.13 Spring plate
1.2.14 Free end
1.2.15 Snap-in element
1.2.16 Stop
1.2.17 Beveled free end
2 Component, first component
2.1 Opening
2.2 Lateral constriction
2.3 Fastening receptacle
2.4 Nut element
2.5 Latching receptacle
2.6 Latching receptacle
2.7 Component wall
2.8 Ramp
2.9 Guide counter-section
2.10 Counter-stop
4 Component, second component
4.1 Component opening
4.2 Internal thread
4.2.1 Internal thread portion
6 Connecting element
8 Nut element
10 Gap
100 Pedestrian protection system
100 Tolerance compensation device
100.1 Separation point
100.2 Protective element
100.2.1 First connection point
100.2.2 Second connection point
100.2.3 Receptacle
100.2.4 Base unit
100.2.4.1 Bushing
100.2.5 Connecting bolt
100.2.6 Predetermined breaking point
100.2.7 Material reduction
100.2.8 Contact region
100.2.9 Stop
100.2.10 Guide
100.2.11 Distance
100.2.13 Guide bushing
100.2.14 Retaining collar
100.3 Slide
100.3.1 Base region
100.3.2 Side wall
100.3.3 End face
100.3.4 Slide part
100.3.5 Slide part
100.3.6 Latching groove
100.4 First stop element
100.4.1 Latching arm
100.4.2 Latching lug
100.5 Second stop element
100.5.1 Latching arm
100.5.2 Latching lug
100.6 Clearance
100.7 Guide
100.7.1 Base surface
100.7.2 Side surface
100.7.3 First stop counter-element
100.7.4 Second stop counter-element
100.8 Pressure spring element
100.9 Resilient element
100.10 Recess
100.11 Retaining spring
100.12 Retaining element
100.13 Retaining arm
100.13.1 Latching lip
100.14 Compression rib
100.14.1 First compression rib
100.14.2 Second compression rib
100.15 Mount
100.15.1 Guide section
200 Application direction
201 Axial tolerance
202 Arrow
204 Arrow
206 Arrow
208 Arrow
210 Arrow
300 Device/connecting arrangement
300.1 Connection unit
300.2 Screw connection
301 Spacer element
302 Distance extension
303 Internal thread
400 Connection direction
402 Opening direction
x Longitudinal direction, spatial direction
y Transverse direction, spatial direction
z Vertical direction, spatial direction
+z, −z Spatial direction

What is claimed is:

1. A connecting arrangement for connecting two components, comprising at least one connecting unit and additionally a protective element, which has at least one first connection point for connection to the connecting unit and at least one second connection point for connection to at least one of the components, wherein at least one of the connection points and/or the protective element is or are designed to be flexible at least in regions and/or at points when a force is applied.

2. The connecting arrangement according to claim 1, wherein at least one of the connection points and/or the protective element is or are designed to be flexible in some regions such that a connection at this at least one connection point is or can be released automatically.

3. The connecting arrangement according to claim 1, wherein the connecting unit is designed as a tolerance compensation device.

4. The connecting arrangement according to claim 3, wherein the tolerance compensation device has at least one tolerance compensation element, which is formed at least from a base element and a compensation element which is in threaded engagement with the base element and which can move relative to the base element by being rotated in order to compensate for tolerances.

5. The connecting arrangement according to claim 1, wherein the connecting unit and the protective element are designed to be reversibly releasably connected to one another in the region of the first connection point.

6. The connecting arrangement according to claim 1, wherein the at least one component and the protective element are designed to be reversibly releasably connected to one another in the region of the second connection point.

7. The connecting arrangement according to claim 1, wherein the protective element is designed as a spring plate or comprises a resilient portion and the one component or the connecting unit has a ramp, or vice versa, wherein the component or the connecting unit is designed as a spring plate in portions or comprises a resilient portion and the protective element has a ramp.

8. The connecting arrangement according to claim 1, wherein the protective element is, on the one hand, rigidly or releasably connectable to the connecting unit and, on the other hand, releasably connectable to the one component.

9. The connecting arrangement according to claim 1, wherein the protective element is designed as a spring element.

10. The connecting arrangement according to claim 1, wherein the protective element and/or at least one of the components is provided with an integrated nut element and/or a corresponding internal thread.

11. The connecting arrangement according to claim 1, wherein the protective element has a snap-in element or clamping element at a free end.

12. The connecting arrangement according to claim 7, wherein the ramp has a flatter rise in the connecting direction than in the opposite opening direction.

13. The connecting arrangement according to claim 1, wherein at least one compression rib is provided for the clearance-free connection of the two components.

14. The connecting arrangement according to claim 1, wherein a connecting element is provided which is or can be coupled to the protective element through the connecting unit.

15. A protective system for a headlight, comprising the connecting arrangement according to claim 1.

16. A vehicle apparatus comprising a protective system according to claim 15.
